(19) United States
(12) Patent Application Publication
(10) Pub. No.: US 2020/0320416 A1
(43) Pub. Date: Oct. 8, 2020

(54) Selective Inference Generation with Distributed Machine-Learned Models

(71) Applicant: Google LLC, Mountain View, CA (US)

(72) Inventors: Nicholas Gillian, Palo Alto, CA (US); Ivan Poupyrev, Sunnyvale, CA (US); Gerard Pallipuram, Cupertino, CA (US)

(21) Appl. No.: 16/839,966

(22) Filed: Apr. 3, 2020

(30) Foreign Application Priority Data
Apr. 5, 2019 (US) PCT/US2019/025984

(51) Int. Cl. G06N 5/04; G06N 20/20

(52) U.S. Cl. CPC G06N 5/043; G06N 20/20

(57) ABSTRACT

A computing system includes at least a first computing device and a second computing device that is physically separate from the first computing device. The computing devices comprise a plurality of processors and a plurality of non-transitory computer-readable media that collectively store a multi-headed machine-learned model that is distributed across the computing devices. The multi-headed machine-learned model comprises a first model head provisioned at the first computing device and configured to receive sensor data from one or more sensors. The first model head is configured to generate a first set of feature representations based at least in part on the sensor data. The multi-headed machine-learned model comprises a second model head provisioned at the second computing device and configured to generate a second set of feature representations in response to receiving data associated with the first set of feature representations from the first computing device.

### FIELD

The present disclosure relates generally to machine-learned models for generating inferences based on sensor data.

### BACKGROUND

Detecting gestures and other motions using wearables and other devices that may include computing devices with limited computational resources (e.g., processing capabilities, memory, etc.) can present a number of unique considerations. Machine-learned models are often used as part of gesture detection and movement recognition processes that are based on input sensor data. Sensor data such as touch data generated in response to touch input, or motion data generated in response to user motion, can be input to one or more machine-learned models. The machine-learned models can be trained to generate one or more inferences based on the input sensor data. These inferences can include detections, classifications, and/or predictions of gestures and/or movements. By way of example, a machine-learned model may be used to determine if input sensor data corresponds to a swipe gesture or other intended user input.

Traditionally, machine-learned models have been deployed at edge device(s) including client devices where the sensor data is generated, or at remote computing devices such as server computer systems that have a larger number of computational resources compared with the edge devices. Deploying a machine-learned model at an edge device has the benefit that raw sensor data is not required to be transmitted from the edge device to a remote computing device for processing. However, edge devices often have limited computational resources that may be inadequate for deploying complex machine-learned models. Additionally, edge devices may have limited power supplies that may be insufficient to support large processing operations while also providing a useful device. Deploying a machine-learned model at a remote computing device with additional processing capabilities than those provided by the edge computing device can seem a logical solution in many cases. However, using a machine-learned model at a remote computing device may require transmitting sensor data from the edge device to the one or more remote computing devices. Such configurations can lead to privacy concerns associated with transmitting user data from the edge device, as well as bandwidth considerations relating to the amount of raw sensor data that can be transmitted.

### SUMMARY

Aspects and advantages of embodiments of the present disclosure will be set forth in part in the following description, or may be learned from the description, or may be learned through practice of the embodiments.

One example aspect of the present disclosure is directed to a computing system comprising a plurality of computing devices including at least a first computing device and a second computing device that is physically separate from the first computing device. The plurality of computing devices comprises a plurality of processors; and a plurality of non-transitory computer-readable media that collectively store a multi-headed machine-learned model that is distributed across the plurality of computing devices. The multi-headed machine-learned model comprises a first model head provisioned at the first computing device and configured to receive sensor data from one or more sensors. The first model head is configured to generate a first set of feature representations based at least in part on the sensor data. The multi-headed machine learned model comprises a second model head provisioned at the second computing device and configured to generate a second set of feature representations in response to receiving data associated with the first set of feature representations from the first computing device.

One example aspect of the present disclosure is directed to a computer-implemented method to train a multi-headed machine-learned model. The method comprises obtaining, by at least a first computing device, data descriptive of the multi-headed machine-learned model. The multi-headed machine-learned model is configured for distribution across a plurality of computing devices including a second computing device and a third computing device. The multi-headed machine-learned model comprises a first model head configured for provisioning at the second computing device and a second model head configured for provisioning at the third computing device. The method comprises obtaining, by at least the first computing device, one or more training constraints representative of one or more computing parameters associated with at least one of the second computing device or the third computing device. The method comprises training, by at least the first computing device, the multi-headed machine-learned model based on a set of training data and the one or more training constraints. Training, by at least the first computing device, the multi-headed machine-learned model comprises determining, by at least the first computing device, one or more parameters of a loss function based on the one or more training constraints and the set of training data; and modifying, by at least the first computing device, at least a portion of the multi-headed machine-learned model based at least in part on the one or more parameters of the loss function.

One example aspect of the present disclosure is directed to a computing device comprising one or more processors and one or more non-transitory computer-readable media that collectively store a first head of a multi-headed machine-learned model that is configured for distribution across a plurality of computing devices including the computing device. The multi-headed machine-learned model is configured to generate inferences associated with at least one of a gesture detection or a movement recognition. The multi-headed machine-learned model comprises a first model head provisioned at the computing device and configured to receive input data. The first model head is configured to generate a first set of feature representations based at least in part on the input data and to selectively generate at least one inference based at least in part on the input data and one or more inference criteria.

Other example aspects of the present disclosure are directed to systems, apparatus, computer program products (such as tangible, non-transitory computer-readable media but also such as software which is downloadable over a communications network without necessarily being stored in non-transitory form), user interfaces, memory devices, and electronic devices for communicating with a touch sensor comprising a set of conductive threads conformal to an embroidered thread pattern.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a block diagram of an example computing environment in which a distributed machine-learned model in accordance with example embodiments of the present disclosure may be implemented.

FIG. 2 depicts a block diagram of an example computing environment that includes an interactive object in accordance with example embodiments of the present disclosure.

FIG. 3 depicts an example of a capacitive touch sensor in accordance with example embodiments of the present disclosure.

FIG. 4 illustrates an example of a conductive thread in accordance with example embodiments of the present disclosure.

FIG. 5 depicts an example of a computing environment including a multi-headed machine-learned model having a plurality of secondary heads and at least one primary head distributed at a plurality of computing devices in accordance with example embodiments of the present disclosure.

FIG. 6 depicts an example of a secondary head of the multi-headed machine-learned model in accordance with example embodiments of the present disclosure.

FIG. 7 depicts a flowchart describing an example method of selectively generating inference data by secondary head of the multi-headed machine-learned model in accordance with example embodiments of the present disclosure.

FIG. 8 depicts a block diagram of a multi-headed machine-learned model including training of the multi-headed machine-learned model by backpropagation of a sub-gradient.

FIG. 9 depicts a flowchart describing an example method of training a multi-headed machine-learned model in accordance with example embodiments of the present disclosure.

FIG. 10 depicts a block diagram of an example computing system for training and deploying multi-headed machine-learned model in accordance with example embodiments of the present disclosure.

FIG. 11 depicts a block diagram of an example computing device that can be used to implement example embodiments in accordance with the present disclosure.

FIG. 12 depicts a block diagram of an example computing device that can be used to implement example embodiments in accordance with the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally, the present disclosure is directed to machine-learned models such as neural networks, non-linear models, and/or linear models, for example, that are distributed across a plurality of computing devices to detect user movements based on sensor data generated at an interactive object. More particularly, a multi-headed machine-learned model is provisioned at a plurality of computing devices and is configured to generate one or more inferences based on sensor data obtained at the interactive object. The multi-headed machine-learned model can include a plurality of model heads. Each model head can be provisioned at or on at least one of the plurality of computing devices. At least one of the model heads can be configured to selectively generate inferences based at least in part on inference criteria provided by the machine-learned model. For instance, the at least one model head can be configured to transmit inference data or feature representation data to an additional model head at another one of the plurality of computing devices based on the inference criteria.

In accordance with some implementations, a multi-headed machine-learned model can be trained to generate inferences at an optimal head of the machine-learned model. In this manner, the amount of data transmitted between computing devices and/or other resource utilizations can potentially be reduced. For example, the multi-headed machine-learned model can be trained to generate an inference at any early stage of the multi-headed machine-learned model if a sufficient amount of feature data has been generated, without passing the feature data to an additional model head at another computing device. This can be contrasted with traditional machine-learned models that include a single output location where inferences are generated without respect to optimization of where such inference is generated.

According to some example embodiments, a machine-learned model head can be trained to selectively generate at least one inference based at least in part on sensor data and one or more inference criteria. For instance, the machine-learned model can determine whether a set of feature representations includes a threshold amount of data for generating an inference. The machine-learned model can generate an inference if the set of feature representations includes the threshold amount of data, or can transmit data indicative of the set of feature representations if the set of feature representations does not include the threshold amount of data. Other types of inference criteria can be used, such as a measure of the quality of the feature representations that have been generated. The one or more inference criteria, such as a threshold amount and/or quality of data, can be learned by training the multi-headed machine-learned model end-to-end. In some examples the multi-headed machine-learned model can learn a variable threshold.

According to some implementations, at least one model head of the multi-headed machine-learned model can be configured to generate a set of feature representations based at least in part on input data received from a sensor and/or one or more other model heads of the multi-headed machine-learned model. The at least one model head can determine whether an inference should be generated locally based on the set of feature representations. For example, the at least one model head can utilize one or more inference criteria to determine whether it should generate the inference locally, or whether data indicative of the set of feature representations should be transmitted to one or more other computing devices at which the multi-headed machine-learned model is provisioned. If the set of feature representations satisfies the one or more inference criteria, the inference can be generated locally. If the set of feature representations fails to satisfy the one or more inference criteria, data indicative of the set of feature representations can be transmitted to one or more additional model heads of the multi-headed machine-learned model provisioned at other computing devices.

In some examples, the portion of a multi-headed machine-learned model at a particular computing device can generate less than all of the data for a feature and/or data for less than all of features to be determined by the model. The multi-headed model can generate an inference at an earlier stage of the model if the feature data is sufficient to generate the inference. For example, a portion of a multi-headed model for image classification may be distributed across devices. A first model head may be able to determine by calculating less than all of the feature data for an image of a solid color, that no faces are present in the image. In such an example, the first model head may generate an inference of no face detection without transmitting feature data to another model head. If the image is of a more complicated scene, however, the first model head may generate a percentage of each feature or a subset of the features, then transmit data based on the features to another model head for additional processing.

According to some implementations, the at least one model head can generate a set of compressed feature representations that are transmitted to another computing device storing later stages of the model. For example, a multi-headed machine-learned model can use compression parameters to compress feature representations prior to transmission between computing devices. For instance, in the event that a model head determines that an inference should not be generated locally based on a set of feature representations, it can compress the feature representations using one or more compression parameters. A set of compressed feature representations can be generated and transmitted to another computing device.

Different compression parameters can be learned for individual ones of the model heads of a multi-headed machine-learned model. For example, a first model head configured to be provisioned at a first computing device can be trained to learn one or more compression parameters for generating a set of compressed feature representations that are transmitted to a second computing device. The one or more compression parameters can be optimized for the first computing device and/or the second computing device. In some examples, one or more compression parameters are optimized for the transition between computing devices, such as by optimizing based on the available bandwidth between the computing devices. Similarly, other model heads such as a second model head provisioned at the second computing device, can be trained to learn a second set of compression parameters. The second set of compression parameters can be optimized for the second computing device and/or another computing device such as a third computing device storing one or more model heads of the model.

According to some implementations, the multi-headed machine-learned model can be distributed across a plurality of computing devices that includes one or more computing devices at an interactive object. For example, the multi-headed machine-learned model can be configured to detect one or more gestures or classify one or more user movements associated with the interactive object. The plurality of computing devices can additionally include one or more computing devices at a local computing device such as smart phone, desktop, tablet, etc. Additionally or alternatively, the plurality of computing devices can include one or more remote computing devices, such as one or more computing devices of a cloud computing system.

A first secondary head of the multi-headed machine-learned model can be provisioned at a first computing device of the interactive object. The first secondary head can be configured to receive sensor data from one or more sensors of the interactive object such as a capacitive touch sensor and/or an inertial measurement unit. The first secondary head can generate one or more feature representations based on the sensor data. The first secondary head can determine whether the one or more feature representations are sufficient for generating an inference at the first computing device.

The first secondary head can utilize one or more inference criteria to determine whether to generate the inference at the first computing device. By way of example, the first secondary head can determine whether the one or more feature representations include a threshold amount of data. In some examples, the multi-headed machine-learned model is trained to determine the threshold amount of data for the first secondary head. In another example, the first secondary head can determine whether the one or more feature representations satisfy one or more threshold quality criteria. If the first secondary head determines that the inference should be generated at the first computing device, the first secondary head can generate the inference. An inference generated at the first computing device may be utilized by the first computing device, such as to initiate an action at the first computing device based on detecting a gesture or user movement. Additionally or alternatively, the first computing device can transmit data indicative of the inference to an additional computing device.

If the first model head determines that an inference should not be generated at the first computing device, the first secondary head can compress the set of feature representations. In some examples, one or more compression parameters can be utilized to compress the set of feature representations into a set of compressed feature representations. In some embodiments, the one or more compression parameters can be learned by training the multi-headed machine-learned model. In some examples, the one or more compression parameters are based at least in part on the first computing device or a second computing device to which the set of compressed feature representations is to be transmitted. The one or more compression parameters can additionally or alternatively be based on the transition between the first computing device and the second computing device. For example, the one or more compression parameters can be based on the bandwidth between the computing devices and/or a distance between the computing devices. The first model head can transmit the set of compressed feature representations from the first computing device to the second computing device. The second computing device can store one or more later stages of the model, such as a second secondary head of the model. The second secondary head of the multi-headed machine-learned model can be provisioned at the second computing device.

The second computing device can be an additional computing device of the interactive object in some examples. For example, the interactive object may include a removable electronics module including the second computing device. In other examples, the second computing device can be a local computing device such as a smart phone, desktop, etc., or a remote computing device such as a computing device of a cloud computing system. In response to receiving data indicative of a set of compressed feature representations from the first computing device, the second model head can compute a second set of feature representations. In some examples, the second set of feature representations may include the first set of compressed feature representations.

Similar to the first model head, the second model head can determine whether an inference should be generated at the second computing device, or whether data indicative of the second set of feature representations should be transmitted to another computing device storing another model head of the model. The second model head can be trained to determine whether to generate an inference based on a second set of inference criteria. For example, the second model head may utilize a second threshold amount of data to determine whether the second set of feature representations is sufficient to generate an inference.

If the second model head determines that an inference should not be generated at the second computing device, the second secondary head can compress the second set of feature representations. The second model head can use one or more second compression parameters to generate a second set of compressed feature representations. The one or more second compression parameters can be different from the one or more first compression parameters used by the first model head. The second compression parameters can be learned by training the multi-headed machine-learned model using training parameters for the second model head. In some examples, the training parameters are associated with one or more of the second computing device or a third computing device storing one or more model heads of the model. In some examples, the one or more compression parameters are based at least in part on computing parameters associated with the second computing device or the third computing device to which the second set of compressed feature representations is to be transmitted. The second model head can transmit the second set of compressed feature representations from the second computing device to the third computing device. The third head of the multi-headed machine-learned model can be provisioned at the third computing device.

The third computing device can be a remote computing device such as a cloud computing system. The third model head can be a primary model head of the multi-headed machine-learned model in some examples. In response to receiving the second set of compressed feature representations from the second computing device, the third model head can compute a third set of feature representations. In some examples, the third set of feature representations may include the first set of compressed feature representations and/or the second set of compressed feature representations. The primary model head can be trained to generate an inference based on a received set of feature representations. It is noted that three computing devices are described by way of example only. For instance, four computing devices may be utilized in an implementation where an interactive object includes the first computing device within an internal electronics module and the second computing device is part of a removable electronics module. A third local computing device may include a third model head and a fourth remote computing device (e.g., of a cloud computing system) may include a fourth model head. Numerous other examples are contemplated in which a multi-headed machine-learned model may have portions of the model distributed at different locations.

In accordance with example embodiments, the multi-headed machine-learned model can be trained in an end-to-end framework remote from at least one of the plurality of computing devices at which the model is configured to be provisioned. For example, the model can be trained at a training computing system that is physically separate from the plurality of computing devices at which the multi-headed machine-learned model is to be provisioned. The training computing system can include one or more computing devices such as one or more servers configured as a cloud computing environment. In some examples, one or more model heads can be additionally or alternatively trained while provisioned at a computing device, such as a local computing device or at an electronic module of the object. For instance, a model head can be refined based on sensor data generated in response to a particular user and/or a particular device.

The plurality of model heads of the multi-headed machine-learned model can be jointly trained at the training computing system, such as by backpropagation to learn one or more compression parameters for individual model heads and/or one or more inference criteria associated with the plurality of model heads. By training a model end-to-end, the training computing system can jointly optimize the entire model for generating inferences (e.g., gesture or movement classifications, detections, predictions, etc.). More particularly, the multi-headed machine-learned model can be trained to dynamically generate inferences at optimal locations within the model provisioned across the plurality of computing devices. Additionally, the model can be trained to determine one or more compression parameters that are used to generate a set of compressed feature representations for transmission between computing devices.

In accordance with some implementations, a training computing system can train a multi-headed machine-learned model end-to-end using techniques that simulate the plurality of computing devices at which the multi-headed machine-learned model is to be provisioned. Additionally or alternatively, the training computing system can simulate transitions between the plurality of computing devices. The training computing system can obtain data that describes a multi-headed machine-learned model that is configured for distribution across a plurality of computing devices. The plurality of computing devices can include at least a first computing device and a second computing device. The multi-headed machine-learned model can include a first model head that is configured for provisioning at the first computing device, and can include a second model head that is configured for provisioning at the second computing device.

The training computing system can obtain training constraints associated with individual ones of the model heads of the multi-headed machine-learned model. The individual model heads are configured to be provisioned at individual computing devices. Additionally or alternatively, the training system can obtain training constraints associated with transitions between the computing devices at which the model is distributed. By way of example, the first set of training constraints can be associated with a first model head to be provisioned at a first computing device. The first set of training constraints can be based on computing parameters associated with the first computing device. In some examples, the first set of training constraints can additionally be associated with the second computing device or another computing device where a portion of the model is implemented. A second set of training constraints can be associated with the second model head to be provisioned at the second computing device. The second set of training constraints can be based on computing parameters associated with the second computing device. In some examples, the second set of training constraints can additionally be associated with a third computing device at a subsequent compute point storing a portion of the model. In this manner, the training constraints can simulate the individual compute points and/or transitions within compute points at which the multi-headed machine-learned model will be distributed.

The model training computing system can train the multi-headed machine-learned model based on a set of training data and the training constraints. The training computing system can train the multi-headed machine-learned model by determining one or more parameters of a loss function based on the training constraints and the set of training data. The model training computing system can modify at least a portion of the multi-headed machine-learned model based at least in part on the one or more parameters of the loss function. For example, one or more of the model heads of the multi-headed machine-learned model can be modified based on backpropagation of a sub-gradient of the loss function. In some examples, a sub-gradient can be calculated for individual model heads of the multi-headed machine-learned model. In other examples, a single sub-gradient can be calculated based on a final output of the model and can be used to train multiple ones of the model heads.

In accordance with some example embodiments, one or more secondary heads of a multi-headed machine-learned model can include one or more feature generation layers. The one or more feature generation layers can be implemented as one or more layers of a neural network, in some examples. The feature generation layers can be configured to receive input data such as sensor data from one or more sensors and/or previously calculated feature data such as data indicative of a set of compressed feature representations generated by a previous model head of the multi-headed machine-learned model. The input data can be input to the one or more feature generation layers which can generate as an output a set of one or more feature representations. In some examples, the feature representations include feature projections. The one or more feature representations can be provided to one or more gate layers of the secondary head of the multi-headed machine-learned model.

The one or more gate layers can be implemented as one or more layers of a neural network in some examples. The gate layer(s) can analyze the set of feature representations to determine whether an inference should be generated by the secondary model head, or whether data indicative of the feature representations should be transmitted to an additional portion of the multi-headed machine-learned model. By way of example, the gate layers can analyze the set of feature representations using a set of inference criteria that is learned by training the multi-headed machine-learned model. In some examples, the inference criteria can include a threshold that is indicative of an amount of feature representation data that should be present before an inference is generated at a particular head of the multi-headed machine-learned model. In other examples, the inference criteria can include data indicative of a type or other attribute associated with the feature representations that is to be present for generating an inference. The gate layers can compare the set of feature representations with the inference criteria to determine whether an inference should be generated by the secondary head. If the gate layers determine that an inference should be generated locally by the secondary head, the set of feature representations can be provided to one or more inference generation layers. If the gate layers determine that an inference should not be generated locally, the feature representations can be provided to one or more compression layers.

The one or more inference generation layers can be implemented as one or more layers of a neural network in some examples. The one or more inference generation layers can generate one or more inferences based on the set of feature representations. By way of example, the one or more inference generation layers can generate an inference associated with a gesture detection, gesture classification, and/or movement recognition in some examples.

The one or more compression layers can be implemented as one or more layers of a neural network in some examples. The one or more compression layers can generate a set of compressed feature representations based on the set of feature representations generated by the feature generation layers. In some examples, the compression layers can utilize one or more compression parameters to generate the set of compressed feature representations. The one or more compression parameters can be learned by training the multi-headed machine-learned model. In some examples, the compression parameters used at a first computing device can be based on one or more additional computing devices of the plurality of computing devices at which the multi-headed machine-learned model is provisioned. In this manner, the set of compressed feature representations can be generated or optimized for the next computing device storing a portion of the model. The set of feature representations can be compressed while avoiding over-compression that may otherwise result in difficulty with feature generation and/or inference generation at subsequent model heads of the multi headed machine-learned model. In some examples, the feature generation layers, the gate layers, the compression layers, and/or the inference generation layers can be implemented within a single set of one or more layers of a neural network.

As a specific example, an interactive object in accordance with some example embodiments can include a capacitive touch sensor comprising one or more conductive lines such as conductive threads. A touch input to the capacitive touch sensor can be detected by the one or more conductive lines using sensing circuitry connected to the one or more conductive lines. The sensing circuitry can generate sensor data based on the touch input. The sensor data can be analyzed by a multi-headed machine-learned model as described herein to detect one or more gestures based on the touch input. For instance, the sensor data can be provided to a first secondary head of the multi-headed machine-learned model implement by a first computing device of the interactive object. The first model head can generate one or more inferences locally or transmit a set of feature representations (e.g., compressed feature representations) to another model head of the trained multi-headed machine-learned model.

As another example, an interactive object can include an inertial measurement unit configured to generate sensor data indicative of acceleration, velocity, and other movements. The sensor data can be analyzed by a multi-headed machine-learned model as described herein to detect or recognize movements such as running, walking, sitting, jumping or other movements. In some examples, a removable electronics module can be implemented within a shoe or other garment, garment accessory, or garment container. The sensor data can be provided to a first secondary head of the multi-headed machine-learned model implemented by a computing device of the removable electronics module at the interactive object. The first model head can generate one or more inferences or a set of compressed feature representations based on the trained multi-headed machine-learned model.

In some examples, a gesture manager and/or movement recognition manager can be implemented at one or more of the computing devices at which the multi-headed machine-learned model is provisioned. The gesture manager may include one or more portions of the multi-headed machine-learned model in some examples. In some examples, the gesture manager may include portions of the multi-headed machine-learned model at multiple ones of the computing devices at which the multi-headed machine-learned model is provisioned. The gesture manager can be configured to initiate one or more actions in response to detecting the gesture or recognizing a user movement. For example, the gesture manager can be configured to provide data indicative of the detected gesture or user movement to other applications at a computing device. By way of example, a detected user movement can be utilized within a health monitoring application or a game implemented at a local or remote computing device. A detected gesture can be utilized by any number of applications to perform a function within the application.

As a specific example, a multi-headed machine-learned model can be configured to detect a user movement such as running. In such an example, an inertial measurement unit may generate sensor data which is provided to a first secondary head of a multi-headed machine-learned model. The first secondary head can be implemented at an electronics module configured to be implemented at or within an interactive object such as a garment. In many cases, it is desirable for reasons of weight, form factor, heat avoidance, user convenience, or other reasons for the electronics module associated with the first secondary head to be a relatively low-power, long-battery-life device, and therefore it may have limited-scale processing ability in comparison to other higher power devices. The first model head may generate a first set of feature representations based on the sensor data. The first model head can determine whether the first set of feature representations is sufficient for generating an inference as to whether the user is running or not. By way of example, the first model head can be trained to generate a first set of feature representations based on the sensor data. If the first set of feature representations is indicative of a user walking, the first model head can determine that the user is not running, and therefore that the inference should be generated locally. The first model head can then generate an inference that the user is not running and utilize it locally, or transmit it to one or more other computing devices.

If the first set of feature representations is not sufficient for determining whether the user is walking or running, the first model head can be configured to generate a set of compressed feature representations which is transmitted to a second model head of the multi-headed machine-learned model. Depending on the particular desired implementation, the second model head can be a second secondary head or can be a primary head. For the case in which the second model head is a second secondary head, can be implemented, for example, on a smart phone beating. By the user, such smartphone generally having substantially higher scale processing ability in comparison to that of the first model head. In this manner, computing resources and bandwidth can be conserved based on an intelligent reasoning as to where and by which computing device to perform inference generation. If it is possible, and the system determines that the local computing resources are appropriate for generating the inference, the model head can generate an inference locally without transmitting data indicative of feature representations. If, however, the feature representations generated locally are not sufficient, the model head can be configured to transmit a set of compressed feature representations to another computing device. Additionally, the first model head can be trained to compress the first set of feature representations based on one or more learned compression parameters associated with the first computing device and/or additional computing devices at which the multi-headed machine-learned model is provisioned.

Systems and methods in accordance with the disclosed technology provide a number of technical effects and benefits. As one example, the systems and methods described herein can enable a distributed computing system to optimally select where the computing system is to generate inferences associated with a machine-learned model based on sensor data. Such systems and methods can permit minimal computational resources to be utilized, which can result in faster and more efficient execution relative to systems that statically generate inferences at a predetermined location. For example, in some implementations, the systems and methods described herein can be quickly and efficiently performed by a computing system including multiple computing devices at which a multi-headed machine-learned model is distributed. Because the multi-headed machine-learned model can dynamically generate an inference at an optimal location of the computing system, the inference generation process can be performed more quickly and efficiently due to the reduced computational demands.

As another example, the systems and methods described here can enable a distributed computing system to optimize feature compression for transmitting feature data between computing devices. More particularly, a machine-learned model can be trained to learn an optimal compression for various transitions within the computing system, such as those between different computing devices. The optimization can be performed jointly based on computing parameters associated with multiple ones of the computing devices in the computing system. More particularly, the optimization can be based on computing parameters associated with a location of a model head, or computing parameters associated with a computing device at which the model head is to transmit feature representations. By optimizing the compression of feature representations, minimal computational resources can be utilized.

As such, aspects of the present disclosure can improve gesture detection, movement recognition, and other machine-learned processes that are performed using sensor data collected at relatively lightweight computing devices, such as those included within interactive objects. In this manner, the systems and methods described here can provide a more efficient operation of a machine-learned model across multiple computing devices in order to perform classifications and other processes efficiently. For instance, a first model head can be optimized for the minimal computing resources available at a client computing device while another model head can be optimized for greater amount of computing resources available at another computing device. By optimizing each of the model heads, the location of inference generation to be optimized. Additionally, bandwidth usage and other computational resources can be minimized.

In some implementations, in order to obtain the benefits of the techniques described herein, the user may be required to allow the collection and analysis of location information associated with the user or her device. For example, in some implementations, users may be provided with an opportunity to control whether programs or features collect such information. If the user does not allow collection and use of such signals, then the user may not receive the benefits of the techniques described herein. The user can also be provided with tools to revoke or modify consent. In addition, certain information or data can be treated in one or more ways before it is stored or used, so that personally identifiable information is removed. As an example, a computing system can obtain real-time location data which can indicate a location, without identifying any particular user(s) or particular user computing device(s).

With reference now to the figures, example aspects of the present disclosure will be discussed in greater detail.

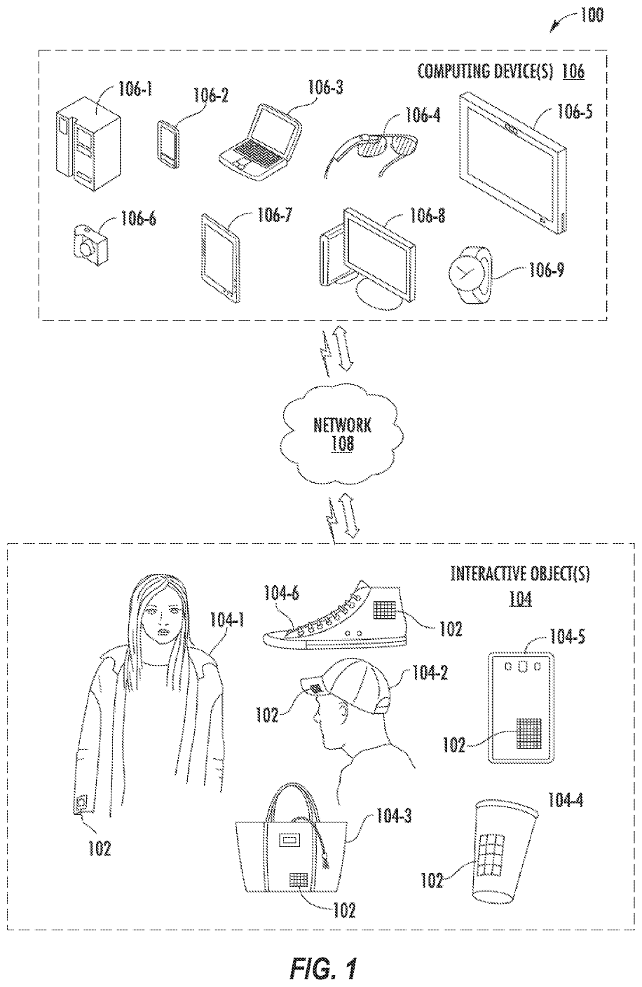

FIG. 1 is an illustration of an example environment 100 including an interactive object associated with a multi-headed machine-learned model in accordance with example embodiments of the present disclosure. Environment 100 includes various interactive objects 104 which can include a capacitive touch sensor 102 or other input device. Capacitive touch sensor 102 can be integrated as an interactive textile or other flexible interactive material that is configured to sense touch-input (e.g., multi-touch input). As described herein, a textile may include any type of flexible woven material consisting of a network of natural or artificial fibers, often referred to as thread or yarn. Textiles may be formed by weaving, knitting, crocheting, knotting, pressing threads together or consolidating fibers or filaments together in a nonwoven manner.

In environment 100, interactive objects 104 include “flexible” objects, such as a shirt 104-1, a hat 104-2, a handbag 104-3 and a shoe 104-6. It is to be noted, however, that capacitive touch sensor 102 may be integrated within any type of flexible object made from fabric or a similar flexible material, such as garments or articles of clothing, garment accessories, garment containers, blankets, shower curtains, towels, sheets, bed spreads, or fabric casings of furniture, to name just a few. Examples of garment accessories may include sweat-wicking elastic bands to be worn around the head, wrist, or bicep. Other examples of garment accessories may be found in various wrist, arm, shoulder, knee, leg, and hip braces or compression sleeves. Headwear is another example of a garment accessory, e.g. sun visors, caps, and thermal balaclavas. Examples of garment containers may include waist or hip pouches, backpacks, handbags, satchels, hanging garment bags, and totes. Garment containers may be worn or carried by a user, as in the case of a backpack, or may hold their own weight, as in rolling luggage. Capacitive touch sensor 102 may be integrated within flexible objects 104 in a variety of different ways, including weaving, sewing, gluing, and so forth.

In this example, objects 104 further include “hard” objects, such as a plastic cup 104-4 and a hard smart phone casing 104-5. It is to be noted, however, that hard objects 104 may include any type of “hard” or “rigid” object made from non-flexible or semi-flexible materials, such as plastic, metal, aluminum, and so on. For example, hard objects 104 may also include plastic chairs, water bottles, plastic balls, or car parts, to name just a few. In another example, hard objects 104 may also include garment accessories such as chest plates, helmets, goggles, shin guards, and elbow guards. Alternatively, the hard or semi-flexible garment accessory may be embodied by a shoe, cleat, boot, or sandal. Capacitive touch sensor 102 may be integrated within hard objects 104 using a variety of different manufacturing processes. In one or more implementations, injection molding is used to integrate capacitive touch sensors into hard objects 104.

Capacitive touch sensor 102 enables a user to control an object 104 with which the capacitive touch sensor 102 is integrated, or to control a variety of other computing devices 106 via a network 108. Computing devices 106 are illustrated with various non-limiting example devices: server 106-1, smart phone 106-2, laptop 106-3, computing spectacles 106-4, television 106-5, camera 106-6, tablet 106-7, desktop 106-8, and smart watch 106-9, though other devices may also be used, such as home automation and control systems, sound or entertainment systems, home appliances, security systems, netbooks, and e-readers. Note that computing device 106 can be wearable (e.g., computing spectacles and smart watches), non-wearable but mobile (e.g., laptops and tablets), or relatively immobile (e.g., desktops and servers). Computing device 106 may be a local computing device, such as a computing device that can be accessed over a bluetooth connection, near-field communication connection, or other local-network connection. Computing device 106 may be a remote computing device, such as a computing device of a cloud computing system.

Network 108 includes one or more of many types of wireless or partly wireless communication networks, such as a local-area-network (LAN), a wireless local-area-network (WLAN), a personal-area-network (PAN), a wide-area-network (WAN), an intranet, the Internet, a peer-to-peer network, point-to-point network, a mesh network, and so forth.

Capacitive touch sensor 102 can interact with computing devices 106 by transmitting touch data or other sensor data through network 108. Additionally or alternatively, capacitive touch sensor 102 may transmit gesture data, movement data, or other data derived from sensor data generated by the capacitive touch sensor 102. Computing device 106 can use the touch data to control computing device 106 or applications at computing device 106. As an example, consider that capacitive touch sensor 102 integrated at shirt 104-1 may be configured to control the user's smart phone 106-2 in the user's pocket, television 106-5 in the user's home, smart watch 106-9 on the user's wrist, or various other appliances in the user's house, such as thermostats, lights, music, and so forth. For example, the user may be able to swipe up or down on capacitive touch sensor 102 integrated within the user's shirt 104-1 to cause the volume on television 106-5 to go up or down, to cause the temperature controlled by a thermostat in the user's house to increase or decrease, or to turn on and off lights in the user's house. Note that any type of touch, tap, swipe, hold, or stroke gesture may be recognized by capacitive touch sensor 102.

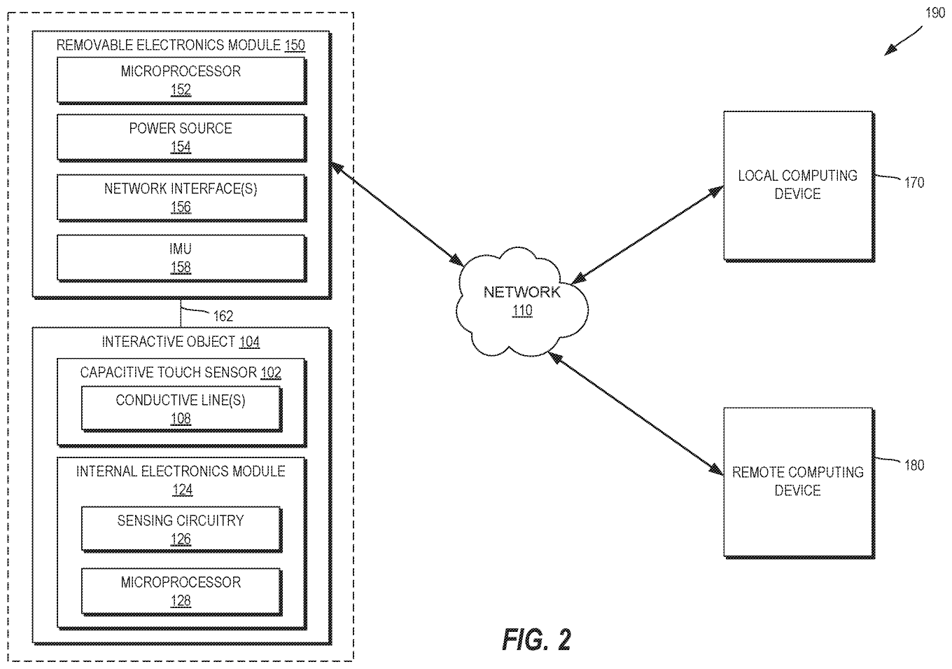

In more detail, consider FIG. 2 which illustrates an example system 200 that includes an interactive object 104, a removable electronics module 150, a local computing device 170, and a remote computing device 180. In system 200, capacitive touch sensor 102 is integrated in an object 104, which may be implemented as a flexible object (e.g., shirt 104-1, hat 104-2, or handbag 104-3) or a hard object (e.g., plastic cup 104-4 or smart phone casing 104-5).

Capacitive touch sensor 102 is configured to sense touch-input from a user when one or more fingers of the user's hand touch capacitive touch sensor 102. Capacitive touch sensor 102 may be configured to sense single-touch, multi-touch, and/or full-hand touch-input from a user. To enable the detection of touch-input, capacitive touch sensor 102 includes conductive lines 110, which can be formed as a grid, array, or parallel pattern so as to detect touch input. In some implementations, the conductive lines 110 do not alter the flexibility of capacitive touch sensor 102, which enables capacitive touch sensor 102 to be easily integrated within interactive objects 104.

Interactive object 104 includes an internal electronics module 124 that is embedded within interactive object 104 and is directly coupled to conductive lines 110. Internal electronics module 124 can be communicatively coupled to a removable electronics module 150 via a communication interface 162. Internal electronics module 124 contains a first subset of electronic circuits or components for the interactive object 104, and removable electronics module 150 contains a second, different, subset of electronic circuits or components for the interactive object 104. As described herein, the internal electronics module 124 may be physically and permanently embedded within interactive object 104, whereas the removable electronics module 150 may be removably coupled to interactive object 104.

In environment 190, the electronic components contained within the internal electronics module 124 includes sensing circuitry 126 that is coupled to conductive lines 110 that form the capacitive touch sensor 102. In some examples, the internal electronics module comprises a flexible printed circuit board (PCB). The printed circuit board can include a set of contact pads for attaching to the conductive lines. In some examples, the printed circuit board includes a microprocessor. For example, wires from conductive threads may be connected to sensing circuitry 126 using flexible PCB, creping, gluing with conductive glue, soldering, and so forth. In one embodiment, the sensing circuitry 126 can be configured to detect a user-inputted touch-input on the conductive threads that is pre-programmed to indicate a certain request. In one embodiment, when the conductive threads form a grid or other pattern, sensing circuitry 126 can be configured to also detect the location of the touch-input on conductive line 110, as well as motion of the touch-input. For example, when an object, such as a user's finger, touches conductive line 108, the position of the touch can be determined by sensing circuitry 126 by detecting a change in capacitance on the grid or array of conductive line 110. The touch-input may then be used to generate touch data usable to control a computing device 106. For example, the touch-input can be used to determine various gestures, such as single-finger touches (e.g., touches, taps, and holds), multi-finger touches (e.g., two-finger touches, two-finger taps, two-finger holds, and pinches), single-finger and multi-finger swipes (e.g., swipe up, swipe down, swipe left, swipe right), and full-hand interactions (e.g., touching the textile with a user's entire hand, covering textile with the user's entire hand, pressing the textile with the user's entire hand, palm touches, and rolling, twisting, or rotating the user's hand while touching the textile).

Communication interface 162 enables the transfer of power and data (e.g., the touch-input detected by sensing circuitry 126) between the internal electronics module 124 and the removable electronics module 150. In some implementations, communication interface 162 may be implemented as a connector that includes a connector plug and a connector receptacle. The connector plug may be implemented at the removable electronics module 150 and configured to connect to the connector receptacle, which may be implemented at the interactive object 104.

In system 200, the removable electronics module 150 includes a microprocessor 152, power source 154, network interface(s) 156, and inertial measurement unit 158. Power source 154 may be coupled, via communication interface 162, to sensing circuitry 126 to provide power to sensing circuitry 126 to enable the detection of touch-input, and may be implemented as a small battery. In one or more implementations, communication interface 162 is implemented as a connector that is configured to connect removable electronics module 150 to internal electronics module 124 of interactive object 104. When touch-input is detected by sensing circuitry 126 of the internal electronics module 124, data representative of the touch-input may be communicated, via communication interface 162, to microprocessor 152 of the removable electronics module 150. Microprocessor 152 may then transmit the touch-input data and/or analyze the touch-input data to generate one or more control signals, which may then be communicated to computing device 106 (e.g., a smart phone) via the network interface 156 to cause the computing device 106 to initiate a particular functionality. Generally, network interfaces 156 are configured to communicate data, such as touch data, over wired, wireless, or optical networks to computing devices 106. By way of example and not limitation, network interfaces 156 may communicate data over a local-area-network (LAN), a wireless local-area-network (WLAN), a personal-area-network (PAN) (e.g., Bluetooth™), a wide-area-network (WAN), an intranet, the Internet, a peer-to-peer network, point-to-point network, a mesh network, and the like (e.g., through network 108).

The inertial measurement unit(s) (IMU(s)) 158 can generate sensor data indicative of a position, velocity, and/or an acceleration of the interactive object. The IMU(s) 158 may generate one or more outputs describing one or more three-dimensional motions of the interactive object 104. The IMU(s) may be secured to the internal electronics module 124, for example, with zero degrees of freedom, either removably or irremovably, such that the inertial measurement unit translates and is reoriented as the interactive object 104 is translated and are reoriented. In some embodiments, the inertial measurement unit(s) 158 may include a gyroscope or an accelerometer (e.g., a combination of a gyroscope and an accelerometer), such as a three axis gyroscope or accelerometer configured to sense rotation and acceleration along and about three, generally orthogonal axes. In some embodiments, the inertial measurement unit(s) may include a sensor configured to detect changes in velocity or changes in rotational velocity of the interactive object and an integrator configured to integrate signals from the sensor such that a net movement may be calculated, for instance by a processor of the inertial measurement unit, based on an integrated movement about or along each of a plurality of axes.

While internal electronics module 124 and removable electronics module 150 are illustrated and described as including specific electronic components, it is to be appreciated that these modules may be configured in a variety of different ways. For example, in some cases, electronic components described as being contained within internal electronics module 124 may be at least partially implemented at the removable electronics module 150, and vice versa. Furthermore, internal electronics module 124 and removable electronics module 150 may include electronic components other that those illustrated in FIG. 2, such as sensors, light sources (e.g., LED's), displays, speakers, and so forth.

A gesture manager can be implemented by one or more computing devices in computing environment 190. The gesture manager can be capable of interacting with applications at computing devices 170 and 180, capacitive touch sensor 102, and/or IMU(s) 158. The gesture manager is effective to activate various functionalities associated with computing devices (e.g., computing devices 106) and/or applications through touch-input (e.g., gestures) received by capacitive touch sensor 102 and/or motion detected by IMU(s) 158. The gesture manager may be implemented at a computing device that is local to object 104, or remote from object 104. Additionally or alternatively, a movement manager can be implemented by computing system 200. The movement manager can be capable of interacting with applications at computing devices and inertial measurement unit 158 effective to activate various functionalities associated with computing devices and/or applications through movement detected by inertial measurement unit 158. The movement manager can be implemented at a computing device 106 that is local to object 104 (e.g., local computing device 170), or remote from object 104 (e.g., remote computing device 180).

The gesture manager and/or movement manager can utilize one or more machine-learned models for detecting gestures and movements associated with interactive object 104. As described in more detail hereinafter, the one or more machine-learned models can be distributed across a plurality of computing devices. For example, a machine-learned model can be distributed at microprocessor 128, microprocessor 152, local computing device 170, and/or remote computing device 180.

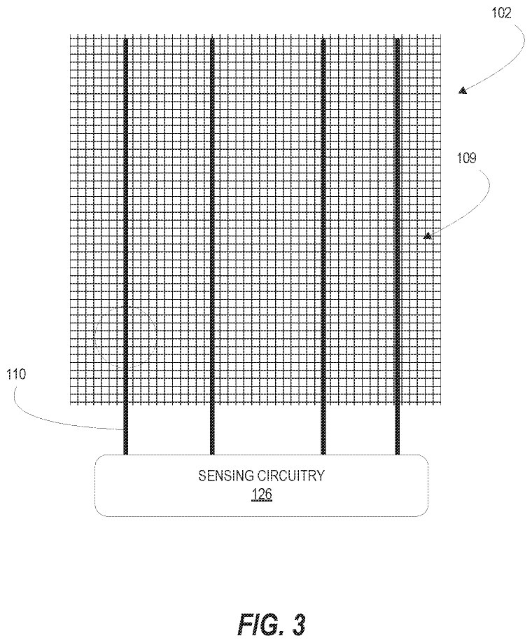

FIG. 3 illustrates an example 300 of interactive object 104 including a capacitive touch sensor 102 formed with conductive threads in accordance with one or more implementations. In this example, interactive object 104 includes non-conductive threads 109 forming a flexible substrate of capacitive touch sensor 102. Non-conductive threads 109 may correspond to any type of non-conductive thread, fiber, or fabric, such as cotton, wool, silk, nylon, polyester, and so forth. Although FIG. 3 provides an example with respect to conductive threads, it will be appreciated that other conductive lines such as conductive fibers, filaments, sheets, fiber optics and the like may be formed in a similar manner.

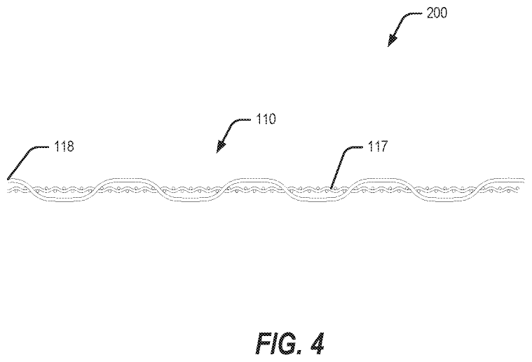

FIG. 4 illustrates an example 200 of a conductive line in accordance with one or more embodiments. In example 200, conductive line 110 is a conductive thread. The conductive thread includes a conductive wire 118 that is combined with one or more flexible threads 117. Conductive wire 118 may be combined with flexible threads 117 in a variety of different ways, such as by twisting flexible threads 117 with conductive wire 118, wrapping flexible threads 117 with conductive wire 118, braiding or weaving flexible threads 117 to form a cover that covers conductive wire 118, and so forth. Conductive wire 118 may be implemented using a variety of different conductive materials, such as copper, silver, gold, aluminum, or other materials coated with a conductive polymer. Flexible thread 117 may be implemented as any type of flexible thread or fiber, such as cotton, wool, silk, nylon, polyester, and so forth.

Combining conductive wire 118 with flexible thread 117 causes conductive line 110 to be flexible and stretchy, which enables conductive line 110 to be easily woven with one or more non-conductive threads 109 (e.g., cotton, silk, or polyester). In one or more implementations, conductive thread includes a conductive core that includes at least one conductive wire 118 (e.g., one or more copper wires) and a cover layer, configured to cover the conductive core, that is constructed from flexible threads 117. In some cases, conductive wire 118 of the conductive core is insulated. Alternately, conductive wire 118 of the conductive core is not insulated.

In one or more implementations, the conductive core may be implemented using a single, straight, conductive wire 118. Alternately, the conductive core may be implemented using a conductive wire 118 and one or more flexible threads 117. For example, the conductive core may be formed by twisting one or more flexible threads 117 (e.g., silk threads, polyester threads, or cotton threads) with conductive wire 118, or by wrapping flexible threads 308 around conductive wire 306.

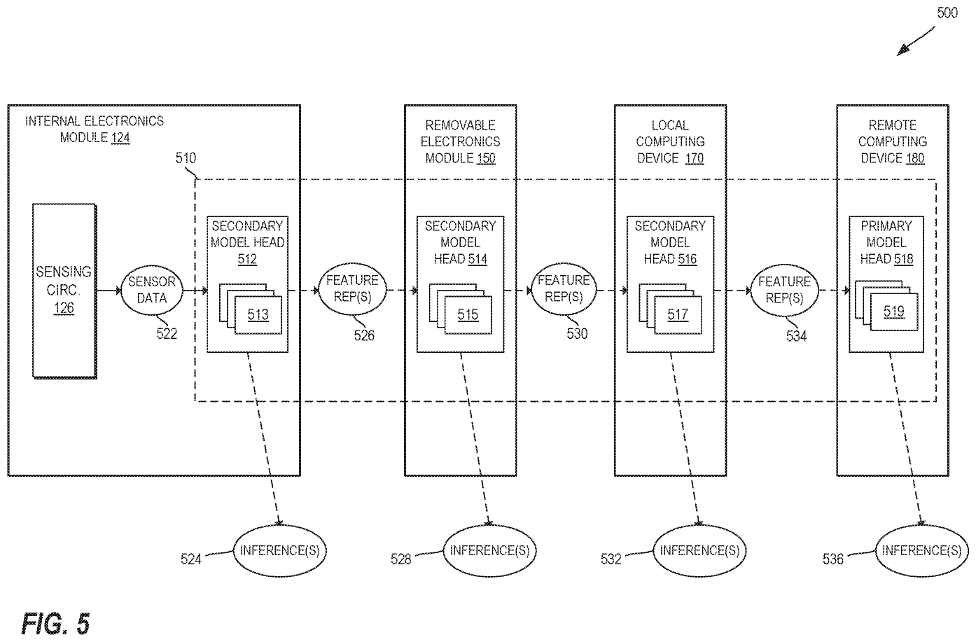

FIG. 5 is a block diagram depicting an example computing environment 500 in which a multi-headed machine-learned model is provisioned in accordance with an example implementation of the present disclosure. Computing environment 500 includes an internal electronics module 124 which may comprise one or more computing devices including a microprocessor 128, and removable electronics module 150 which may comprise one or more computing devices including microprocessor 152, as earlier described. Additionally, computing environment 500 includes a local computing device 170 and a remote computing device 180. A multi-headed machine-learned model 510 is distributed across the plurality of computing devices. More particularly, multi-headed machine-learned model 510 includes a first secondary model head 512 provisioned at a first computing device of the internal electronics module 124, a second secondary model head 514 provisioned at a second computing device of the removable electronics module 150, a third secondary model head 516 provisioned at a local computing device 170, and a primary model head 518 provisioned at a remote computing device 180. It is noted that four computing devices and four model heads are provided by way of example only. For example, a multi-headed machine-learned model may include a single secondary head provisioned at a first computing device and a single primary head provisioned at a second computing device. In other examples, more than three secondary heads may be provisioned using additional computing devices.

Secondary model head 512 at internal electronics module 124 can include one or more layers of at least one neural network or other machine-learned network. Similarly, secondary model head 514 includes one or more layers of at least one neural network or other machine-learned network, secondary model head 516 includes one or more layers of at least one neural network or other machine-learned network, and primary model head 518 includes one or more layers of at least one neural network or other machine-learned network.

The first secondary model head 512 is configured to receive sensor data 522 generated by sensing circuitry 126. For example, secondary model head 512 may receive sensor data 522 generated in response to touch input provided to a capacitive touch sensor 102. In another example, secondary model head 512 may receive sensor data 522 generated in response to motion detected by an inertial measurement unit 158. Secondary model head 512 is configured to receive the sensor data and generate one or more feature representations 513 based on the sensor data. For example, a secondary model head 512 of a multi-headed machine-learned model 510 configured for gesture detection may generate one or more feature representations 513 that are representative of the touch input provided to capacitive touch sensor 102. In another example, a secondary model head 512 of a multi-headed machine-learned model 510 configured for movement recognition may be configured to use to generate one or more feature representations 513 that are representative of motion of a user detected by inertial measurement unit 158. Notably, the first set of feature representations 526 comprise less than all of the feature representation data that multi-headed machine-learned model 510 is configured to generate in order to make one or more inferences based on input data. For example, secondary model head 512 may include one or more layers configured to generate a predetermined amount of feature representation data based on the input sensor data. For instance, secondary model head 512 may represent roughly 20% of the feature generation layers included within multi-headed machine-learned model 510. As such, the first set of feature representations 513 may represent roughly 20% of the feature representation data that can be generated by the multi-headed machine-learned model 510. In some examples, secondary model head 512 may generate 20% of each of a plurality of features. In other examples, secondary model head 512 may generate all of the feature data for 20% of the total number of features.

Secondary model head 512 is configured to selectively generate one or more inferences 524 based on the feature representations generated by secondary model head 512. For example, secondary model head 512 may compare the feature representations generated by secondary model head 512 with one or more inference criteria. If the feature representations satisfy the one or more inference criteria, secondary model head 512 can generate one or more inferences based on the feature representations. If, however, the feature representations do not satisfy the one or more inference criteria, secondary model head 512 can compress the one or more feature representations 513 into a set of one or more compressed feature representations 526. The secondary model head 512 can transmit the set of compressed feature representations 526 to removable electronics module 150 including secondary model head 514. In another example, secondary model head 512 may transmit compressed feature representations 526 directly to secondary model head 516 at local computing device 170 and/or primary model head 518 at remote computing device 180.

Secondary model head 514 provisioned at removable electronics module 150 receives the compressed feature representations 526 from the internal electronics module 124. The compressed feature representations 526 can be input to the secondary model head which can perform additional processing to generate another set of feature representations 515 at the secondary model head 514. In some examples, the second set of feature representations 515 can include one or more of the first set of feature representations 513. Removable electronics module 150 provides the set of compressed feature representations 526 as an input to the multi-headed machine-learned model 510. One or more feature generation layers can be provided at secondary model head 514 and configured to generate the second set of feature representations 515. The second set of feature representations 530 can include less than all of the feature representation data that multi-headed machine-learned model 510 is configured to generate in order to make one or more inferences based on an initial input. For example, secondary model head 514 may include one or more layers configured to generate a predetermined amount of feature representation data based on the first set of feature representations. For instance, secondary model head 514 may represent roughly 20% of the feature generation layers included within multi-headed machine-learned model 510. The second set of feature representations may represent a combination of the first set of feature representation data as well as feature data generated by the secondary model head 514. As such, the second set of feature representations 530 may represent roughly 40% of the feature representation data that is generated by the multi-headed machine-learned model 510.

Secondary model head 514 determines whether to generate one or more inferences 528 based on the second set of feature representations 515. For example, secondary model head 514 may utilize one or more inference criteria to determine whether to generate the one or more inferences 528. In some examples, the one or more inference criteria are machine-learned inference criteria. By way of example, secondary model head 514 may utilize one or more thresholds indicative of an amount of data that should be present before calculating the one or more inferences 528. In another example, the one or more inference criteria may include a threshold indicative of a quality level associated with the one or more feature representations that should be present prior to generating the one or more inferences 528. It is noted, that the one or more inference criteria utilized by secondary model head 514 can be different than the one or more inference criteria utilized by secondary model head 512. More particularly, the one or more inference criteria utilized by secondary model has 514 can be generated by training multi-headed machine-learned model 510 based on particular training constraints associated with the secondary model head 514. Similarly the one or more inference criteria utilized by secondary model head 512 can be generated by training the multi-headed machine-learned model 510 based on training constraints associated with secondary model head 512.

If the second set of feature representations satisfies the one or more inference criteria, secondary model head 514 can generate one or more inferences 528 based on the feature representations. If, however, the feature representations do not satisfy the one or more inference criteria, secondary model head 514 can compress the one or more feature representations 515 into a set of one or more compressed feature representations 530. The secondary model head 514 can transmit the set of compressed feature representations 530 to local computing device 170 including secondary model head 516. In another example, secondary model head 514 may transmit compressed feature representations 530 directly to primary model head 518 at remote computing device 180.

Secondary model head 516 is configured to receive the second set of compressed feature representations 530 generated by secondary model head 514. Secondary model head 516 is configured to generate one or more feature representations 517 based on the second set of compressed feature representations 530. The third set of feature representations 571 comprises less than all of the feature representation data that multi-headed machine-learned model 510 is configured to generate in order to make one or more inferences based on input data. For example, secondary model head 516 may include one or more layers configured to generate a predetermined amount of feature representation data based on the input sensor data. For instance, secondary model head 516 may represent roughly 30% of the feature generation layers included within multi-headed machine-learned model 510. The third set of feature representations 517 may represent a combination of the first set of feature representations 513, the second set of feature representations 515, and the feature representation data generated by secondary model head 516. As such, the third set of feature representations 517 may represent roughly 70% of the feature representation data that is generated by the multi-headed machine-learned model 510.

Secondary model head 516 is configured to selectively generate one or more inferences 532 based on the feature representations generated by secondary model head 516. For example, secondary model head 516 may compare the feature representations generated by secondary model head 516 with one or more inference criteria. If the feature representations satisfy the one or more inference criteria, secondary model head 516 can generate one or more inferences based on the feature representations. If, however, the feature representations do not satisfy the one or more inference criteria, secondary model head 516 can compress the one or more feature representations 517 into a third set of one or more compressed feature representations 534. The secondary model head 516 can transmit the set of compressed feature representations 534 to remote computing device 180 including primary model head 518.

Primary model head 518 is configured to receive the third set of compressed feature representations 534 generated by secondary model head 516. Primary model head 518 is configured to generate one or more feature representations 519 based on the third set of compressed feature representations 534. The third set of feature representations 519 includes the full feature representation data that multi-headed machine-learned model 510 is configured to generate in order to make one or more inferences based on input data. For example, primary model head 518 may include one or more layers configured to generate the final portion of the feature representations for the multi-headed machine-learned model 510. Primary model head 518 may represent another 30% of the feature generation layers included within multi-headed machine-learned model 510. The fourth set of feature representations 519 may represent a combination of the first set of feature representations 513, the second set of feature representations 515, the third set of feature representations 517, and the feature representation data generated by primary model head 518. As such, the fourth set of feature representations 519 may include 100% percent of the feature representation data that is generated by the multi-headed machine-learned model 510. Primary model head 518 is configured to generate one or more inferences 536 based on the feature representations generated by primary model head 518.

In another example (not shown), sensor data may be provided directly to a secondary model head 514 of removable electronics module 150. For example, inertial measurement unit 158 may generate sensor data locally at removable electronics module 150. The sensor data from the inertial measurement unit may be provided directly to a secondary model head 514 removable electronics module 150.

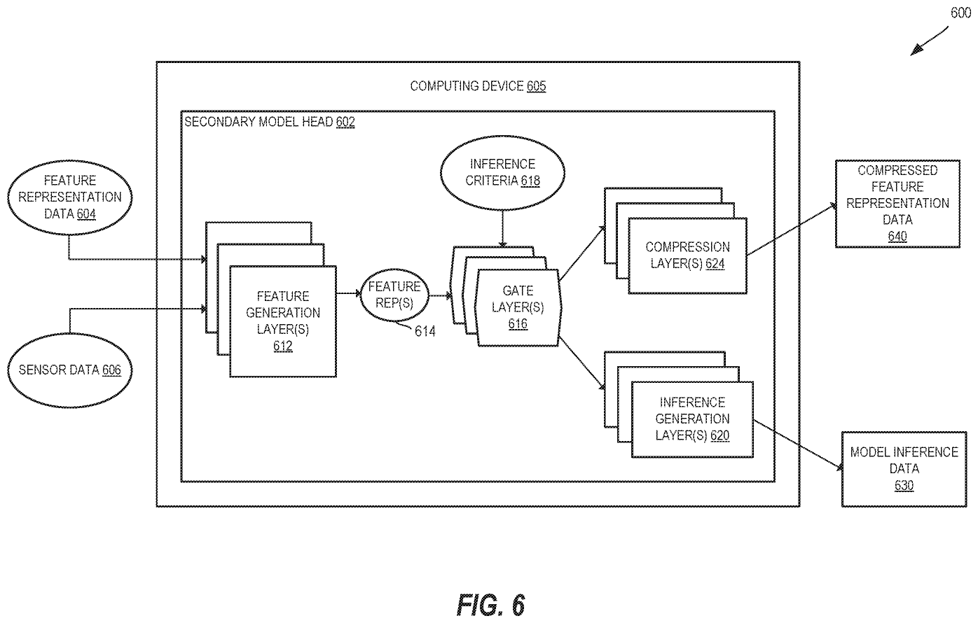

FIG. 6 is a block diagram depicting an example of a secondary model head of a multi-headed machine-learned model in accordance with example embodiments of the present disclosure. Secondary model head 602 is provisioned at a computing device 605. Computing device 605 may include a computing device at an internal electronics module 124, a removable electronics module 150, a local computing device 170, or a remote computing device 180. Secondary model head 602 is configured to receive feature representation data 604 and/or sensor data 606. In some examples, a multi-headed machine-learned model 510 may be multimodal such that it can receive input data of different data types. For example, multi-headed machine-learned model 510 may be configured to receive sensor data from one or more sensors and feature representations as may be generated from one or more model heads at an earlier stage of the multi-machine-learned model. Additionally or alternatively, multi-headed machine-learned model 510 may be configured to receive sensor data of different types, such as sensor data from different types of sensors (e.g., capacitive touch sensor and inertial measurement unit).

Feature representation data 604 and/or sensor data 606 is provided as one or more inputs to one or more feature generation layers 612. Feature generation layers 612 are configured to generate feature representation data 614 including one or more feature representations in response to input data such as a feature representation data and/or sensor data. Feature generation layers 612 may include one or more neural networks or other type of machine-learned models, including non-linear models and/or linear models. Neural networks can include feed-forward neural networks, recurrent neural networks (e.g., long short-term memory recurrent neural networks), convolutional neural networks or other forms of neural networks. The feature representation data 614 may include various intermediate stage information relating to an overall inference process performed by the multi-headed machine-learned model. By way of example, feature representation data 614 may include data representative of motion features, position features, physical features, timing features, facial features, or any other type of feature suitable for an inference process associated with the multi-headed machine-learned model of a specific example.

The multi-headed machine-learned model may be configured to generate an inference indicative of a gesture detection in some examples. More particularly, the inference may be an indication of whether the corresponding gesture was detected based on input sensor data or feature representations generated in response to touch data provided to a capacitive touch sensor. In such an example, feature representation data 614 may include detection features associated with touch input provided to the capacitive touch sensor. The features may be representative of one or more conductive lines that detect a touch input, a timing associated with the touch input, a speed associated with the touch input, or any other suitable feature associated with a gesture detection process. Such features may include early-stage features associated with one or more layers at an early stage of a machine-learned model, or late stage features associated with one or more layers at a later stage in the machine-learned model. As a specific example, early-stage features may be indicative of one or more conductive lines associated with the touch input, whereas one or more late stage features may be indicative of a movement or other motion associated with the touch input.

The one or more feature representations are provided as an input to one or more gate layers 616. The one or more gate layers are configured to receive feature representations as input and compare the feature representations with one or more inference criteria. The one or more inference criteria can be one or more machine-learned inference criteria associated with inference generation by the secondary model head. The one or more gate layers can determine whether one or more feature representations of feature representation data 614 satisfy the one or more inference criteria 618. For example, a gate layer may determine whether an amount of data associated with one or more feature representations satisfies a threshold amount of data. In another example, a gate layer 616 may determine whether the feature representation data 614 includes a sufficient number of features or features of a threshold quality for generating one or more inferences. The one or more gate layers 616 can be trained based on training constraints associated with computing device 106 at which the secondary model head is provisioned, and/or training constraints associated with one or more additional computing devices at which the multi-headed machine-learned model is provisioned.

If gate layer(s) 616 determine that the one or more inferences should be generated locally by the secondary model head 602, the feature representation data 614 can be passed to one or more inference generation layers 620. Inference generation layers process one or more feature representations to generate one or more inferences 630. Inference generation layers 620 may include one or more layers of a neural network or other types of machine-learned models, including non-linear models and/or linear models. The inference generation layers 620 can be trained to generate one or more inferences based on feature representation data 614.

If gate layer(s) 616 determines that the feature representation data 614 does not satisfy the inference criteria 618, the feature representation data 614 can be passed to one or more compression layers 624. Compression layer(s) 624 can apply one or more machine-learned compression parameters to generate compressed feature representation data 640. The one or more compression parameters can be learned by training the secondary model head 602 using one or more training constraints associated with computing device 605 and/or another computing device at which the multi-headed machine-learned model is provisioned. By way of example, compression layer(s) 624 can be trained to determine one or more compression parameters that result in an optimal compression based on the bandwidth between computing devices, the processing capabilities of computing devices, the memory available at computing devices, etc. By way of example, and with reference to FIG. 5, one or more compression layers 624 at secondary model head 516 of local computing device 170 can utilize compression parameters that are generated by training secondary model head 602 based on training constraints associated with computing parameters of remote computing device 180. In this manner, secondary model head 602 can be configured to compress the feature representations based on the computing device to which the feature representations will be transmitted.

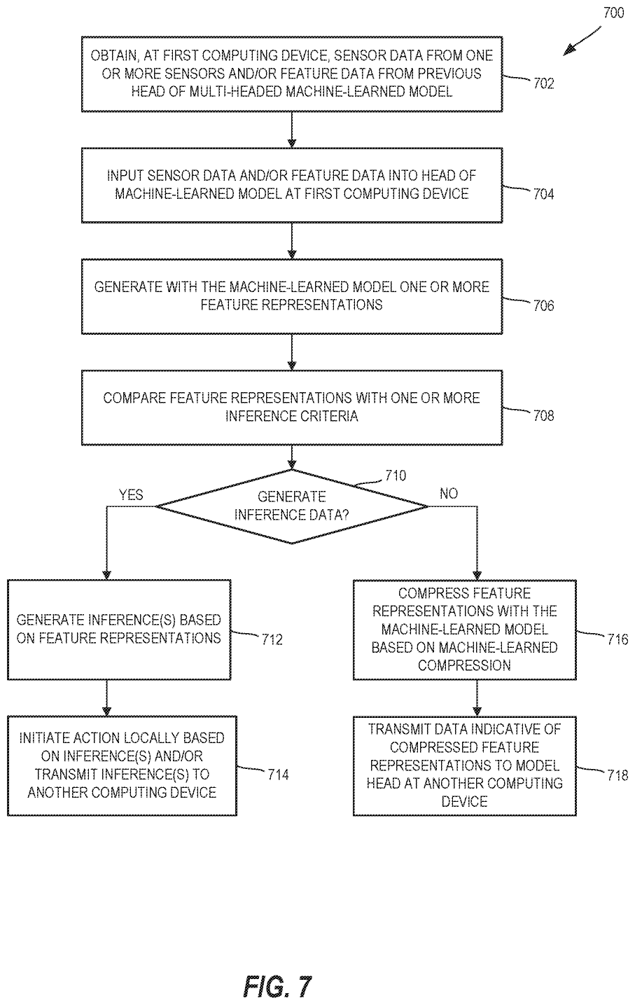

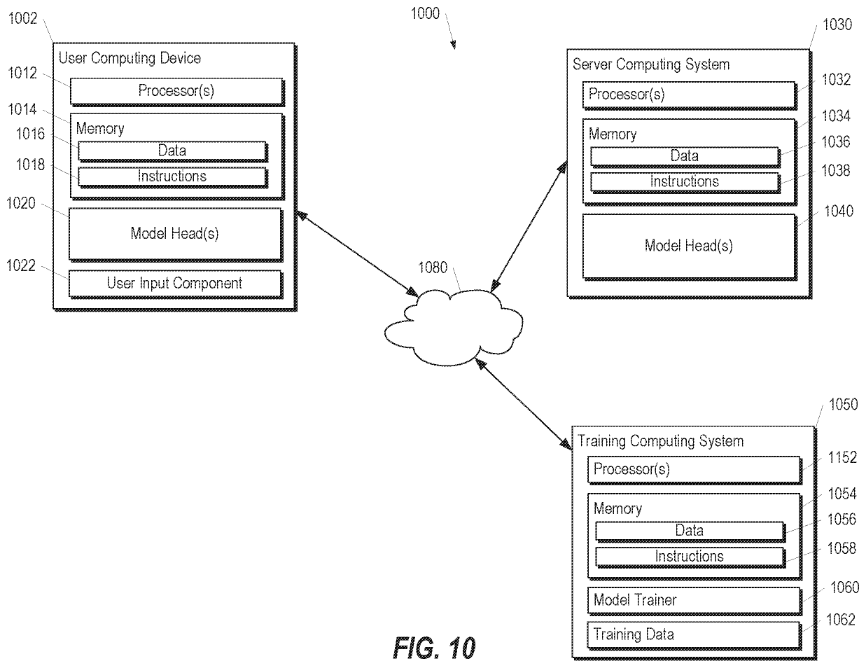

FIG. 7 is a flowchart depicting an example method 700 of processing sensor data by a multi-headed machine-learned model including at least one model head that is configured to selectively generate inferences based on the sensor data and/or feature representations generated by the model head and/or other model heads of the model. One or more portions of method 700 can be implemented by one or more computing devices such as, for example, one or more computing devices of a computing environment 100 as illustrated in FIG. 1, computing environment 190 as illustrated in FIG. 2, or a computing environment 1000 as illustrated in FIG. 10. One or more portions of method 700 can be implemented as an algorithm on the hardware components of the devices described herein to, for example, utilize a multi-headed machine-learned model to process sensor data, generate feature representations, and selectively generate inferences at particular locations of the model. In example embodiments, method 700 may be performed by a secondary model head or a primary model head of a multi-headed machine-learned model as illustrated in FIGS. 5, 6, and/or 8. The model head may be implemented at a computing device of an internal electronics module, a removable electronics module, a local computing device, or a remote computing device as described herein.

At (702), sensor data and/or feature data can be obtained by a first computing device at which a model head of a multi-headed machine-learned model is provisioned. The sensor data can be generated by one or more sensors such as a capacitive touch sensor and/or inertial measurement unit. Input feature data can be generated by another model head of the multi-headed machine-learned model, such as a model head at an earlier stage of the model. For instance, the feature data can be representative of a set of compressed feature representations generated by a model head at an earlier stage of the multi-headed machine-learned model.

At (704), the sensor data and/or feature data is input into the model head of the multi-headed machine-learned model at the first computing device. In some examples, the sensor data and/or feature data can be input sequentially as a set of sensor data or feature data representations. In some examples, the sensor data and/or feature data can be input as a plurality of frames of data representative of a sequence of sensor data inputs.

At (706), the model head can generate one or more feature representations based at least in part on the input sensor data and/or feature data. The one or more feature representations can be generated as the output of one or more stages or layers of the model head at the first computing device. For example, the feature representations may be generated by one or more feature generations layers of the neural network included as part of the model head. In such examples, the feature representations may not be provided as an external output of the multi-headed machine-learned model. In other examples, the one or more feature representations can be provided as an output of a model head of the multi-headed machine-learned model.

At (708), one or more feature representations can be compared with one or more inference criteria. In some examples, the model head of the first computing device can compare the feature representations with the one or more inference criteria. In some examples, inference criteria can be machine-learned inference criteria such as a machine-learned threshold amount of data that should be present in one or more feature representations prior to generating inference data. In other examples, the one or more inference criteria may include a threshold indicative of the quality of the feature representations that should be present before generating inference data. Additionally or alternatively, in some examples, additional logic external to the model head can be used to compare feature representations with inference criteria.

At (710), the computing device determines whether to generate inference data based on comparing the one or more feature representations with the one or more inference criteria. The computing device can determine whether the one or more feature representations satisfy the one or more inference criteria. In some examples, the model head at the computing device can determine whether to generate inference data at (710). In other examples, additional logic external to the model head can be used to determine whether to generate inference data at (710).

If the computing device determines to generate inference data at (710), method 700 continues at (712). At (712), one or more inferences can be generated based at least in part on the one or more feature representations generated at (706). By way of example, an inference as to whether a particular gesture was detected based on touch data generated by a capacitive touch sensor can be generated in some examples. In another example, an inertial measurement unit may generate sensor data indicative of a user movement, and one or more inferences may include an indication as to whether a particular movement was recognized or detected.

At (714), one or more actions can be initiated locally based on the generated inferences. Additionally or alternatively, the one or more inferences can be transmitted to another computing device at (714). For example, data representative of a gesture detection or movement recognition may be provided to one or more applications at the first computing device, which can process the gesture detection or movement recognition to generate an output. By way of example, a user interface may be manipulated in response to a gesture detection. As another example, data representative of the gesture detection or movement recognition may be transmitted to another computing device which can process the gesture detection or movement recognition to generate an output.

If at (710) the computing device determines that inference data should not be generated locally at the first computing device, method (700) continues at (716). At (716), the model head can compress the feature representations based on one or more machine-learned compression parameters. The machine-learned compression parameters may be generated by training the multi-headed machine-learned model using training constraints that correspond to the first computing device or one or more additional computing devices at which the multi-headed machine-learned models is to provisioned. As a specific example, the model head of the first computing device may be trained to compress the feature representations according to compression parameters that are associated with a computing device at which a model head of a later stage of the multi-headed machine-learned model is provisioned.

At (718), data indicative of the compressed feature representations is transmitted to another computing device at which the multi-headed machine-learned model is provisioned. The compressed feature representations can be input to another model head of the multi-headed machine-learned model at the other computing device. The next computing device of the multi-headed machine-learned model can also generate feature representations and determine whether to selectively generate inferences locally or to transmit the feature representations to another computing device.

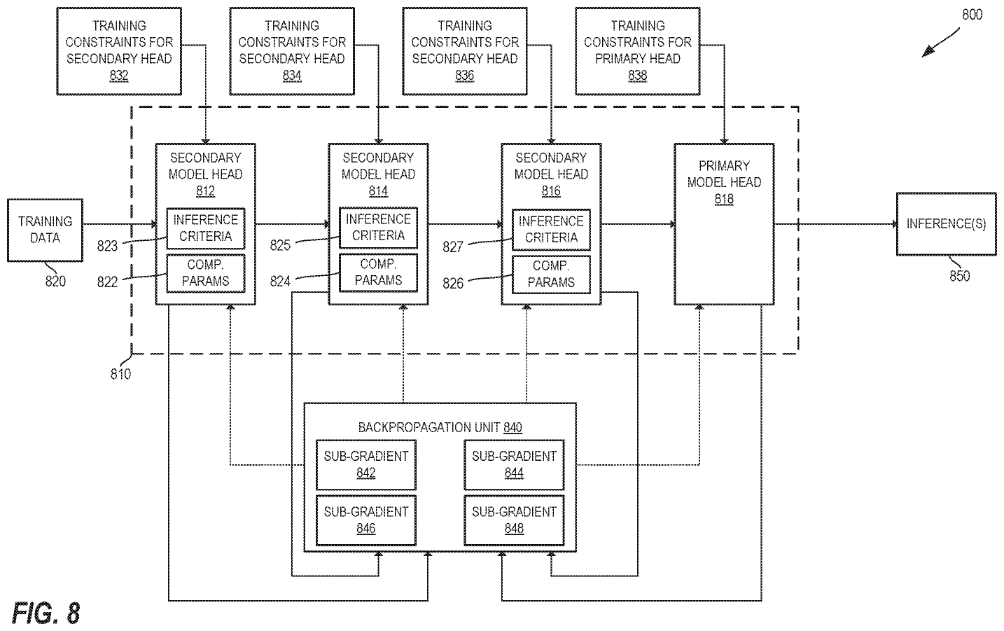

FIG. 8 is a block diagram depicting an example of a multi-headed machine-learned model in accordance with example embodiments of the present disclosure. More particularly, FIG. 8 depicts a multi-headed machine-learned model 810 during a training phase which can be used to generate inference criteria, compression parameters, as well as to tune the multi-headed machine-learned model 810 for generating inferences 850. Multi-headed machine-learned model 810 is configured to receive training data which may include sensor data and/or feature representation data such as may be generated by one or more model heads at a previous stage of the multi-headed machine-learned model. In this example, multi-headed machine-learned model 810 includes secondary model head 812, secondary model head 814, secondary model head 816, and primary model head 818. It will be noted, however, that the use of three secondary model heads and a single primary head is provided by way of sample only. In other examples, multi-headed machine-learned model 810 may include less than or more than three secondary model heads. Each of the secondary model heads 812, 814, 816, as well as the primary model head 818, is configured to be provisioned at a separate computing device. As earlier described, secondary model head 812 may be configured for provisioning at a computing device of an internal electronics module of an interactive object, while secondary model head 814 may be configured for provisioning at a removable electronics module of the interactive object. Secondary model head 816 may be configured for provisioning at a local computing device such as a smart phone, etc., while primary model head 818 may be configured for provisioning at a remote computing system such as a cloud computing system. Other implementations are possible.

During the training phase, multi-headed machine-learned model 810 can be configured at a single computing device physically separate from the computing devices at which the multi-headed machine-learned model will be provisioned during use. For example, a training computing system physically separate from the interactive object, local computing devices, and remote computing devices may be used to train multi-headed machine-learned model 810. Notably, multi-headed machine-learned model 810 can be trained end-to-end at the training computing system. Multi-headed machine-learned model can learn to associate training data 820 with inferences 850. Moreover, multi-headed machine-learned model 810 can learn how to associate training data 820 with an appropriate location or a particular one of the heads for generating inferences 850.

Machine-learned model 810 can be trained end-to-end to jointly optimize each of the model heads for selectively generating inferences based on the feature representations generated by such secondary model head, as well as for generating compressed feature representations. By way of example, each model head can be trained based on detected errors in inferences generated by the particular model head. Additionally, each model head can be trained based on detected errors in the decision as to whether to generate an inference at the secondary model head, or whether to transmit data indicative of the feature representations to another model head. Finally, each model head can be trained based on training constraints which are representative of computing parameters associated with one or more computing devices at which the multi-headed machine-learned model is to be provisioned.

Errors detected in the inferences generated by multi-headed machine-learned model 810 can be back propagated through the multi-headed machine-learned model 810 using a backpropagation unit 840. In some examples, an overall output of multi-headed machine-learned model 810 can be utilized to train each of the secondary model heads and the primary model head. For instance, an output of primary model head 818 can be provided as an input to backpropagation unit 840. Backpropagation unit 840 can generate a sub-gradient 848 based on detected errors in the inferences generated by the primary model head 818. Backpropagation unit 840 can back propagate sub-gradient 848 to secondary model head 812, secondary model head 814, secondary model head 816, and/or primary model head 818 in order to train multi-headed machine-learned model 810 based on detected errors in the inferences 850.

In another example, the outputs of individual secondary model heads and/or the primary model head can be used to train a multi-machine-learned model. For example, an output of secondary model head 812 of multi-headed machine-learned model 810 can be provided as an input to backpropagation unit 840. Backpropagation unit 840 can calculate a sub-gradient 842 based on detected errors in inferences generated by secondary model head 812 and an actual inference represented in the training data. Additionally or alternatively, backpropagation unit 840 can calculate a sub-gradient 842 based on detected errors in a decision by the secondary model head 814 to generate an inference. Moreover, backpropagation unit 840 can calculate a sub-gradient 842 based on a detected error in the amount of compression applied by secondary model head 812 when generating a set of compressed feature representations that are passed to secondary model head 814. The calculated sub-gradient 842 can be back propagated into the multi-headed machine-learned model 810 to train one or more of the model heads for inference generation. In some examples, sub-gradient 842 is activated by backpropagation unit 840 and provided as an input to secondary model head 812. In other examples, backpropagation unit 840 can propagate sub-gradient 842 to one or more additional heads of the multi-headed machine-learned model.

Similarly, an output of secondary model head 814 can be provided as an input to backpropagation unit 840 which can calculate a sub-gradient 844 based on detected errors in inferences generated by secondary model head 814 and/or decision to generate inferences by secondary model head 814. Additionally or alternatively, backpropagation unit 840 can calculate a sub-gradient 844 based on a detected error in the amount of compression applied by secondary model head 814 when generating a set of compressed feature representations that are passed to secondary model head 816. Backpropagation unit 840 can propagate sub-gradient 844 into the machine-learned model 810 at one or more of the secondary model heads and/or the primary head. An output of secondary model head 816 can be provided as an input to backpropagation unit 840, which can calculate a sub-gradient 846 based on detected errors in inferences generated by secondary model head 816 and/or decisions to generate inferences by secondary model head 816. Additionally or alternatively, backpropagation unit 840 can calculate a sub-gradient 846 based on a detected error in the amount of compression applied by secondary model head 816 when generating a set of compressed feature representations that are passed to primary model head 818. Backpropagation unit 840 can propagate sub-gradient 846 into the machine-learned model 810 atone or more of the secondary model head and/or the primary head. An output of primary model head 818 can be provided as a an input to backpropagation unit 840 which can calculate a sub-gradient 848 based on detected errors in inferences generated by primary model head 818. Backpropagation unit 840 can propagate sub-gradient 848 into the machine-learned model 810 at one or more of the secondary model heads and/or the primary head.

Multi-headed machine-learned model 810 can be trained using training data that includes sensor data and/or feature representation data that has been annotated to indicate one or more of an inference (e.g., detection, classification, etc.) represented by the data, a location of where the inference should be generated in a model, compression parameters, or other information. Backpropagation unit 840 can detect errors associated with inferences generated by multi-headed machine-learned model 810, errors associated with the location of generating the inferences, and/or errors associated with compressing feature representations. The errors may be detected by comparing inferences generated by the multi-headed machine-learned model to the annotated sensor data over a sequence of training data. Errors associated with inferences generated by the model can be back propagated to one or more secondary model heads and/or primary model heads to jointly train and optimize the machine-learned model for generating inferences at an appropriate location within the model. Based on back propagating errors, the multi-headed machine-learned model can be modified for generating inferences at an optimal location in the model.

In some examples, multi-headed machine-learned model 810 can be trained based on training data indicative of a location at which an inference should be generated within the multi-headed machine-learned model. Multi-headed machine-learned model 810 can be trained to generate one or more inference criteria 823, 825, 827 for each of the secondary model heads to use in generating determining whether to generate an inference based on input data. In such examples, an output of the secondary model head can be provided to backpropagation unit 840 which can calculate a sub-gradient based on whether the secondary model head correctly chooses whether to generate an inference, or whether to generate a set of compressed feature representations. By way of example, a set of training data including sensor data and/or feature representations data can be annotated to indicate a location within the multi-headed machine-learned model at which an inference should be generated based on such training data. For a particular model head, the annotations may indicate whether the model head to generate an inference or a set of compressed feature representations. As a particular example, a gesture detection model may be trained to generate an inference at an early stage of the model based on sensor data that is annotated to indicate is sufficient for generating inference data. For example, motion data indicative of movement insufficient to satisfy any gesture criteria can be annotated to indicate that an inference of no gesture detection should be generated early in the model, such as by secondary model head 812. By contrast, sensor data indicative of a complex motion may be annotated to indicate that an inference generation should be generated at a later stage of the model, such as at primary model head 818.

In some examples, multi-headed machine-learned model 810 can be trained to generate one or more compression parameters 822, 824, 826 for each of the secondary model heads to use in generating compressed feature representations for transmission between the model heads. A set of training constraints for each secondary model head can be used to train the secondary model head to generate a set of compression parameters. For example, a set of training constraints 832 may be provided as an input to secondary model head 812 during training. The set of training constraints 832 may be based on one or more computing parameters associated with the computing device at which secondary model head 812 is to be provisioned. Additionally or alternatively, training constraints 832 may be based on computing parameters associated with an additional computing device at which multi-headed machine-learned model 810 will be provisioned. For example, one or more training constraints 832 may be based on one or more computing parameters of the computing device at which the secondary model head 814 of a later stage is to be provisioned. In this manner, secondary model head 812 can be trained to generate compression parameters 822 appropriate for the computing device that will receive the set of compressed feature representations. Training constraints include, but are not limited to, bandwidth constraints, memory constraints, processing capability constraints, etc.

Similarly, secondary model head 814 may be trained to generate one or more compression parameters 824 using a second set of training constraints 834. The second set of training constraints 834 may be different than the first set of training constraints 832. Training constraints 834 may be representative of one or more computing parameters associated with a computing device at which secondary model head 812 is to be provisioned, a computing device at which secondary model head 814 is to be provisioned, and/or a computing device at which secondary model head 816 is to be provisioned. In this manner, secondary model head 814 can generate compression parameters 824 based on the computing parameters associated with computing devices at earlier stages in the model, computing devices at later stages and the model, and/or the computing device at which the secondary model head 814 is to be provisioned. In this manner, secondary model head 814 can be trained to generate compression parameters 824 for generating compressed feature representations for the computing device that will receive the set of compressed feature representations.

Secondary model head 816 may be trained to generate one or more compression parameters 826 using a third set of training constraints 836. The third set of training constraints 836 may be different than the first and/or second set of training constraints. Training constraints 834 may be representative of one or more computing parameters associated with a computing device at which secondary model head 816 is to be provisioned, a computing device at which secondary model head 814 is to be provisioned, and/or a computing device at which primary model head 818 is to be provisioned. In this manner, secondary model head 816 can generate compression parameters 826 based on the computing parameters associated with computing devices at an earlier stage in the model, computing devices at a later stage in the model, as well as the computing device at which the secondary model head 816 is to be provisioned. In this manner, secondary model head 816 can be trained to determine compression parameters 826 that generate feature representations optimized for the computing device at a later stage of the model.

Primary model head 818 can be trained using one or more training constraints 838. Training constraints 838 can be based on one or more computer parameters associated with the computing device at which primary model head 818 will be provisioned, and/or one or more computing devices at which one or more of the secondary model heads are to be provisioned.

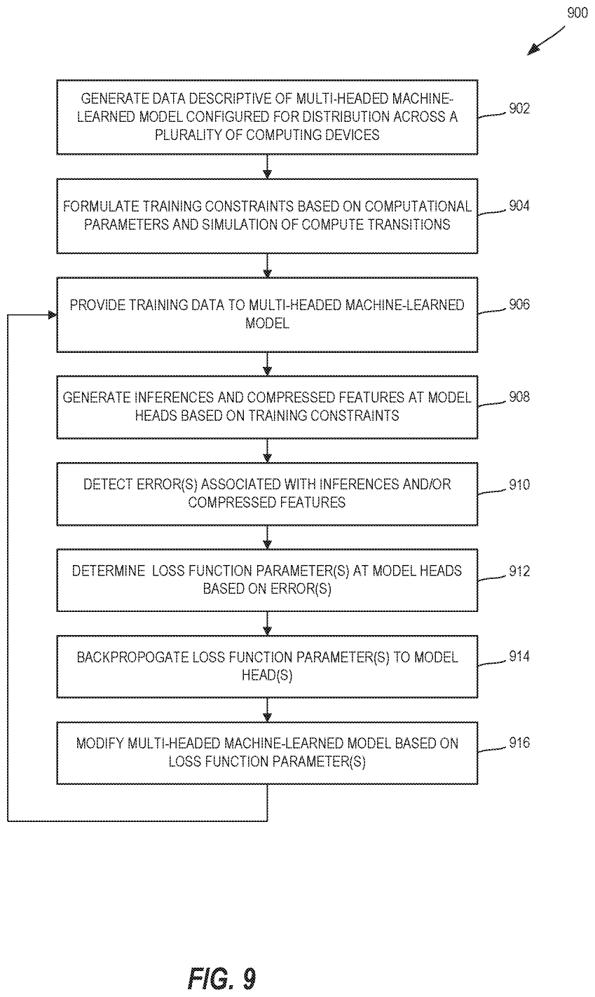

FIG. 9 is a flowchart depicting an example method 900 of training a multi-headed machine-learned model including at least one model head that is configured to selectively generate inferences. The model head can be trained to selectively generate inferences based on sensor data and/or feature representations generated by the model head and/or other model heads of the model. One or more portions of method 900 can be implemented by one or more computing devices such as, for example, one or more computing devices of a computing environment 100 as illustrated in FIG. 1, computing environment 190 as illustrated in FIG. 2, or a computing environment 1000 as illustrated in FIG. 10. One or more portions of method 900 can be implemented as an algorithm on the hardware components of the devices described herein to, for example, train a multi-headed machine-learned model to process sensor data, generate feature representations, and selectively generate inferences at particular locations of the model. In example embodiments, method 900 may be performed by a model trainer 1060 using training 1062 as illustrated in FIG. 10.

At (902), data descriptive of a multi-headed machine-learned model is generated. The multi-headed machine-learned model is configured for distribution across a plurality of computing devices. In some examples, the plurality of computing devices include have different computational resources such as different processing capabilities. For example, the plurality of computing devices may include relatively lightweight computing devices such as may be in an interactive object, computing devices with somewhat larger processing capabilities as may be included in user computing devices, or relatively robust computing devices as may be provided in cloud computing environments including server computing systems etc. In some examples, the data descriptive of the multi-headed machine-learned model is generated at a first computing device, such as a training computing system 1050 at which the multi-headed machine-learned model may be trained end-to-end. In other examples, one or more portions of the data descriptive of the multi-headed machine-learned model may be generated or otherwise provided to other computing devices, such as an edge or client computing device at which the multi-headed machine-learned model will be provisioned.

At (904), one or more training constraints are formulated based on the computational parameters of one or more computing devices at which the multi-headed machine-learned model will be provisioned. In some examples, training constraints can be formulated individually for each of the model heads of a multi-headed machine-learned model. The training constraints for the particular model head can be determined based on the computations resources of the computing device at which the model head will be provisioned, and/or other computing devices for earlier or later stages of the multi-headed machine-learned model. The training constraints for a particular model head may also include training constraints based on transitions between computing devices. For example, a particular model head may be trained based on the bandwidth between the computing device at which the model head is provisioned and a computing device of a model head at an earlier or later stage of the multi-headed machine-learned model.

At (906), training data is provided to the multi-headed machine-learned model. The training data may include sensor data and/or feature representation data. The sensor data and/or feature representation data can be annotated to indicate an inference associated with the corresponding sensor data and/or feature representation data. For instance, the data may be annotated to indicate a gesture or movement represented by the sensor data or feature representation data. In some examples, the training data may additionally include an indication as to where an inference for the respective data should be generated. For instance, the training data may indicate an optimal location within a multi-headed machine-learned model at which to generate an inference based on the corresponding sensor data and/or feature representations data.

At (908), one or more inferences and one or more compressed features are generated at the various model heads of the multi-headed machine-learned model based on the training constraints. For instance, in response to a particular frame of sensor data or feature data, an inference may be generated at one of the model heads of the multi-headed machine-learned model. Additionally, another model had the multi-headed machine-learned model may generate compressed feature representations which are transmitted between various ones of the model heads.

At (910), one or more errors are detected in association with the inferences and/or the compressed feature representations. For example, the model trainer may detect an error with respect to a location at which an inference was generated. The model trainer may determine that an inference is not generated by a particular model head at which the inference should have been generated. In another example, the model trainer may determine that an inference was generated by a particular model head at which the inference should not have been generated. As another example, an error with respect to the content of an inference may be detected. For instance, the model trainer may determine that a model head generated an incorrect inference for a particular frame of sensor data and/or feature data. As another example, an error with respect to the compression of one or more feature representations may be detected. For instance, the model trainer may determine that a model head utilized an inappropriate compression parameter when generating the compressed feature representations. The model trainer may determine that the model head used a compression parameter including a larger or smaller compression relative to an optimal compression.

At (912), one or more loss function parameters can be determined for one or more of the model heads based on the detected errors. In some examples, the loss function parameters can be based on an overall output of the multi-headed machine-learned model. The loss function parameter(s) can be applied to each of the model heads. In other examples, a loss function parameter can be based on the output of an individual model head. In such an example, the loss function parameter can be representative of a loss function parameter for the particular model head. In some examples, a loss function parameter may include a sub-gradient. A sub-gradient can be calculated for each model head individually, or for the multi-headed machine-learned model as a whole.

At (914), the one or more loss function parameters are back propagated to one or more of the model heads. For example, a sub-gradient calculated for a particular model head can be back propagated to that model head as part of (914). In another example, a sub-gradient calculated for the overall multi-headed machine-learned model can be back propagated to each of the model heads.

At (916), one or more portions of the multi-headed machine-learned model can be modified based on the backpropagation at 914. In some examples, a single model head of the multi-headed machine-learned model may be modified based on backpropagation of the loss function parameter. In other examples, multiple model heads of the multi-headed machine-learned model may be modified based on the backpropagation of one or more loss function parameters.

FIG. 10 depicts a block diagram of an example computing system 1000 that performs inference generation according to example embodiments of the present disclosure. The system 1000 includes a user computing device 1002, a server computing system 1030, and a training computing system 1050 that are communicatively coupled over a network 1080.

The user computing device 1002 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 1002 includes one or more processors 1012 and a memory 1014. The one or more processors 1012 can be any suitable processing device (e.g., a processor core, a microprocessor, an ASIC, a FPGA, a controller, a microcontroller, etc.) and can be one processor or a plurality of processors that are operatively connected. The memory 1014 can include one or more non-transitory computer-readable storage mediums, such as RAM, ROM, EEPROM, EPROM, flash memory devices, magnetic disks, etc., and combinations thereof. The memory 1014 can store data 1016 and instructions 1018 which are executed by the processor 1012 to cause the user computing device 1002 to perform operations.

The user computing device 1002 can include one or more portions of a multi-headed machine-learned model, such as one or more model heads. For example, the user computing device 1002 can include a secondary model head or a primary model head of the multi-headed machine-learned model. The one or more model heads 1020 of the multi-headed machine-learned model can perform inference generation such as gesture detection and/or movement recognition as described herein. One example of the one or more model heads 1020 of the multi-headed machine-learned model are shown in FIG. 6. However, systems other than the example system shown in FIG. 6 can be used as well.

In some implementations, the one or more model heads 1020 of the multi-headed machine-learned model can store or include one or more portions of a gesture detection and/or movement recognition model. For example, the multi-headed machine-learned model can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks.

One example multi-headed machine-learned model 510 is discussed with reference to FIG. 5. However, the example model 510 is provided as one example only. The one or more model heads 1020 can be similar to or different from the example model 510.

In some implementations, the one or more model heads 1020 of the multi-headed machine-learned model can be received from the server computing system 1030 over network 1080, stored in the user computing device memory 1014, and then used or otherwise implemented by the one or more processors 1012. In some implementations, the user computing device 1002 can implement multiple parallel instances of the model heads 1020 of the multi-headed machine-learned model (e.g., to perform parallel inference generation across multiple instances of sensor data).

Additionally or alternatively to the model heads 1020 of the multi-headed machine-learned model, the server computing system 1030 can include one or more model heads 1040 of the multi-headed machine-learned model. The model heads 1040 can perform inference generation as described herein. One example of the model heads 1040 can be the same as the system shown in FIG. 5. However, systems other than the example system shown in FIG. 5 can be used as well.

Additionally or alternatively to the model heads 1020 of the multi-headed machine-learned model, one or more model heads 1040 of the multi-headed machine-learned model can be included in or otherwise stored and implemented by the server computing system 130 (e.g., as a component of the multi-headed machine-learned model) that communicates with the user computing device 1002 according to a client-server relationship. For example, the model heads 1040 of the multi-headed machine-learned model can be implemented by the server computing system 1030 as a portion of a web service (e.g., an image processing service). Thus, one or more model heads can be stored and implemented at the user computing device 1002 and/or one or more model heads can be stored and implemented at the server computing system 1030. The one or more model heads 1040 can be the same as or similar to the one or more model heads 1020.

The user computing device 1002 can also include one or more user input components 1022 that receive user input. For example, the user input component 1022 can be a touch-sensitive component (e.g., a capacitive touch sensor 102) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 1030 includes one or more processors 1032 and a memory 1034. The one or more processors 1032 can be any suitable processing device (e.g., a processor core, a microprocessor, an ASIC, a FPGA, a controller, a microcontroller, etc.) and can be one processor or a plurality of processors that are operatively connected. The memory 1034 can include one or more non-transitory computer-readable storage mediums, such as RAM, ROM, EEPROM, EPROM, flash memory devices, magnetic disks, etc., and combinations thereof. The memory 1034 can store data 1036 and instructions 1038 which are executed by the processor 1032 to cause the server computing system 1030 to perform operations.

In some implementations, the server computing system 1030 includes or is otherwise implemented by one or more server computing devices. In instances in which the server computing system 1030 includes plural server computing devices, such server computing devices can operate according to sequential computing architectures, parallel computing architectures, or some combination thereof.

As described above, the server computing system 1030 can store or otherwise include one or more model heads 1040 of the multi-headed machine-learned model. For example, the model heads can be or can otherwise include various machine-learned models. Example machine-learned models include neural networks or other multi-layer non-linear models. Example neural networks include feed forward neural networks, deep neural networks, recurrent neural networks, and convolutional neural networks. One example model is discussed with reference to FIG. 5.

The user computing device 1002 and/or the server computing system 1030 can train the model heads 1020 and 1040 via interaction with the training computing system 1050 that is communicatively coupled over the network 1080. The training computing system 1050 can be separate from the server computing system 1030 or can be a portion of the server computing system 1030.

The training computing system 1050 includes one or more processors 1052 and a memory 1054. The one or more processors 1052 can be any suitable processing device (e.g., a processor core, a microprocessor, an ASIC, a FPGA, a controller, a microcontroller, etc.) and can be one processor or a plurality of processors that are operatively connected. The memory 1054 can include one or more non-transitory computer-readable storage mediums, such as RAM, ROM, EEPROM, EPROM, flash memory devices, magnetic disks, etc., and combinations thereof. The memory 1054 can store data 1056 and instructions 1058 which are executed by the processor 1052 to cause the training computing system 1050 to perform operations. In some implementations, the training computing system 1050 includes or is otherwise implemented by one or more server computing devices.

The training computing system 1050 can include a model trainer 1060 that trains a multi-headed machine-learned model including model heads 1020 and 1040 stored at the user computing device 1002 and/or the server computing system 1030 using various training or learning techniques, such as, for example, backwards propagation of errors. In other examples as described herein, training computing system 1050 can train a multi-headed machine-learned model (e.g., model 510 or 810) prior to deployment for provisioning of the multi-headed machine-learned model at user computing device 1002 or server computing system 1030. The multi-headed machine-learned model including model heads 1020 and model heads 1040 can be stored at training computing system 1050 for training and then deployed to user computing device 1002 and server computing system 1030. In some implementations, performing backwards propagation of errors can include performing truncated backpropagation through time. The model trainer 1060 can perform a number of generalization techniques (e.g., weight decays, dropouts, etc.) to improve the generalization capability of the models being trained.

In particular, the model trainer 1060 can train the model heads 1020 and 1040 based on a set of training data 1062. The training data 1062 can include for example, a plurality of instances of sensor data, where each instance of sensor data has been labeled with ground truth inferences such as gesture detections and/or movement recognitions. For example, the label(s) for each training image can describe the position and/or movement (e.g., velocity or acceleration) of a touch input or an object movement. In some implementations, the labels can be manually applied to the training data by humans. In some implementations, the models can be trained using a loss function that measures a difference between a predicted inference and a ground-truth inference. In implementations which include multi-headed models, the multi-headed models can be trained using a combined loss function that combines a loss at each head. For example, the combined loss function can sum the loss from a secondary head with the loss from a primary head to form a total loss. The total loss can be backpropagated through the model.

In some implementations, if the user has provided consent, the training examples can be provided by the user computing device 1002. Thus, in such implementations, the model head 1020 provided to the user computing device 1002 can be trained by the training computing system 1050 on user-specific data received from the user computing device 1002. In some instances, this process can be referred to as personalizing the model.

The model trainer 1060 includes computer logic utilized to provide desired functionality. The model trainer 1060 can be implemented in hardware, firmware, and/or software controlling a general purpose processor. For example, in some implementations, the model trainer 160 includes program files stored on a storage device, loaded into a memory and executed by one or more processors. In other implementations, the model trainer 1060 includes one or more sets of computer-executable instructions that are stored in a tangible computer-readable storage medium such as RAM hard disk or optical or magnetic media.

The network 1080 can be any type of communications network, such as a local area network (e.g., intranet), wide area network (e.g., Internet), or some combination thereof and can include any number of wired or wireless links. In general, communication over the network 1080 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 10 illustrates one example computing system that can be used to implement the present disclosure. Other computing systems can be used as well. For example, in some implementations, the user computing device 1002 can include the model trainer 1060 and the training data 1062. In such implementations, the model heads 1020 can be both trained and used locally at the user computing device 1002. In some of such implementations, the user computing device 1002 can implement the model trainer 1060 to personalize the model heads 1020 based on user-specific data.

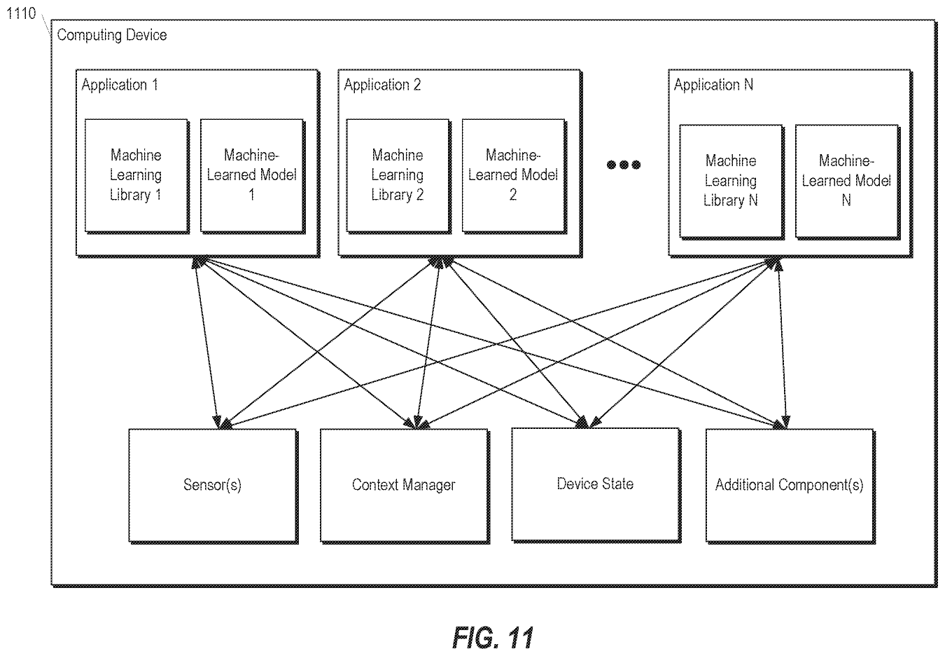

FIG. 11 depicts a block diagram of an example computing device 1110 that performs according to example embodiments of the present disclosure. The computing device 1110 can be a user computing device or a server computing device.

The computing device 1110 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 11, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

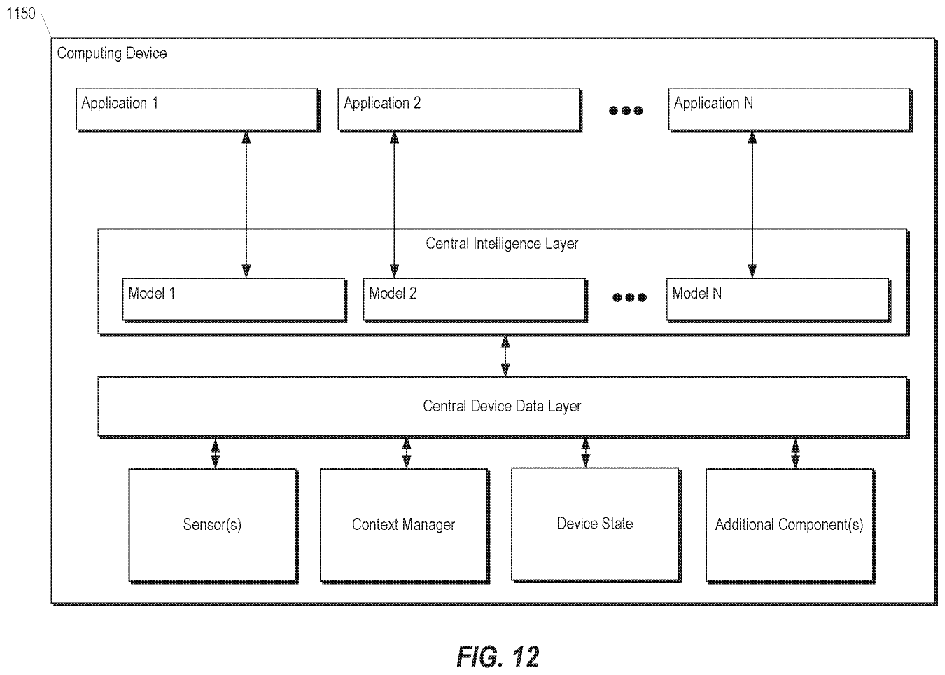

FIG. 12 depicts a block diagram of an example computing device 1150 that performs according to example embodiments of the present disclosure. The computing device 1150 can be a user computing device or a server computing device.

The computing device 1150 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 12, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 1150.

The central intelligence layer can communicate with a central device data layer. The central device data layer can be a centralized repository of data for the computing device 1150. As illustrated in FIG. 12, the central device data layer can communicate with a number of other components of the computing device, such as, for example, one or more sensors, a context manager, a device state component, and/or additional components. In some implementations, the central device data layer can communicate with each device component using an API (e.g., a private API).

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. A computing system comprising a plurality of computing devices including at least a first computing device and a second computing device that is physically separate from the first computing device, the plurality of computing devices comprising:
a plurality of processors; and
a plurality of non-transitory computer-readable media that collectively store a multi-headed machine-learned model that is distributed across the plurality of computing devices, the multi-headed machine-learned model comprising:
a first model head provisioned at the first computing device and configured to receive sensor data from one or more sensors, wherein the first model head is configured to generate a first set of feature representations based at least in part on the sensor data and determine whether the first set of feature representations satisfies one or more machine-learned inference criteria, the first model head configured to generate at least one inference in response to the first set of feature representations satisfying the one or more machine-learned inference criteria and to initiate a transmission of data associated with the first set of feature representations to a second model head at the second computing device in response to the first set of feature representations failing to satisfy the one or more machine-learned inference criteria; and
a second model head provisioned at the second computing device and configured to generate a second set of feature representations in response to receiving the data associated with the first set of feature representations from the first computing device.

2. (canceled)

3. (canceled)

4. The computing system of claim 2, wherein the first model head is configured to:
in response to determining that the first set of feature representations satisfies the one or more machine-learned inference criteria, transmit the at least one inference from the first computing device to the second computing device.

5. The computing system of claim 4, wherein the first model head is configured to:
in response to determining that the first set of feature representations fails to satisfy the one or more machine-learned inference criteria, generate a first set of compressed feature representations based at least in part on the first set of feature representations;
wherein the data associated with the first set of feature representations includes the first set of compressed feature representations.

6. The computing system of claim 5, wherein:
the first set of compressed feature representations is generated using one or more first machine-learned compression parameters; and
the multi-headed machine-learned model is trained to determine the one or more first machine-learned compression parameters based at least in part on one or more first training constraints that are representative of one or more computing parameters associated with at least one of the first computing device or the second computing device.

7. The computing system of claim 6, wherein the one or more machine-learned inference criteria are one or more first machine-learned inference criteria, wherein the second model head is configured to:
determine whether the second set of feature representations satisfies one or more second machine-learned inference criteria;
in response to determining that the second set of feature representations satisfies the one or more second machine-learned inference criteria, generate at least one inference based at least in part on the second set of feature representations; and
in response to determining that the second set of feature representations fails to satisfy the one or more second machine-learned inference criteria, generate a second set of compressed feature representations based at least in part on the second set of feature representations and initiate a data transmission associated with the second set of compressed feature representations from the second computing device to a third model head at a third computing device.

8. The computing system of claim 7, wherein:
the second set of compressed feature representations is generated using one or more second machine-learned compression parameters; and
the multi-headed machine-learned model is trained to determine the one or more second machine-learned compression parameters based at least in part on one or more second training constraints that are representative of one or more computing parameters associated with at least one of the second computing device or the third computing device.

9. The computing system of any of claim 6, wherein:
the one or more first training constraints and the one or more second training constraints include at least one of a bandwidth constraint, a memory constraint, or a processing capability constraint.

10. The computing system of any of claim 2, wherein the one or more machine-learned inference criteria includes a threshold amount of data for inference generation.

11. The computing system of claim 1, wherein:
the one or more sensors include a capacitive touch sensor comprising a set of conductive lines;
the first computing device is communicatively coupled to the capacitive touch sensor; and
the multi-headed machine-learned model is configured to generate inferences associated with detection of at least one gesture based on touch input to the capacitive touch sensor.

12. The computing system of claim 1, wherein:
the one or more sensors include an inertial measurement unit;
the first computing device is communicatively coupled to the inertial measurement unit; and
the multi-headed machine-learned model is configured to generate inferences associated with a movement recognition based on movement of an interactive object including the inertial measurement unit.

13. A computer-implemented method to train a multi-headed machine-learned model, comprising:
obtaining, by at least a first computing device, data descriptive of the multi-headed machine-learned model, wherein the multi-headed machine-learned model is configured for distribution across a plurality of computing devices including a second computing device and a third computing device, the multi-headed machine-learned model comprising a first model head configured for provisioning at the second computing device and a second model head configured for provisioning at the third computing device;
obtaining, by at least the first computing device, one or more training constraints representative of one or more computing parameters associated with at least one of the second computing device or the third computing device; and
training, by at least the first computing device, the multi-headed machine-learned model based on a set of training data and the one or more training constraints, wherein training, by at least the first computing device, the multi-headed machine-learned model comprises:
determining, by at least the first computing device, one or more parameters of a loss function based on the one or more training constraints and the set of training data; and
modifying, by at least the first computing device, at least a portion of the multi-headed machine-learned model based at least in part on the one or more parameters of the loss function.

14. The computer-implemented method of claim 13, wherein modifying, by at least the first computing device, at least the portion of the multi-headed machine-learned model based at least in part on the one or more parameters of the loss function, comprises:
generating one or more inference criteria for determining, by the first model head, whether to transmit an inference generated by the first model head to the second computing device or whether to communicate data indicative of one or more feature representations to the second computing device.

15. The computer-implemented method of any of claim 14, wherein:
the one or more training constraints include a first set of training constraints associated with the second computing device and a second set of training constraints associated with the third computing device; and
training, by at least the first computing device, the multi-headed machine-learned model comprises jointly optimizing, by at least the first computing device, the first model head and the second model head based on a first set of training constraints associated with the second computing device and a second set of training constraints associated with the third computing device.

16. The computer-implemented method of claim 15, wherein jointly optimizing, by at least the first computing device, the first model head and the second model head, comprises:
determining a first set of compression parameters for generating first feature representations by the first model head in response to sensor data associated with one or more sensors; and
determining a second set of compression parameters for generating second feature representations by the second model head in response to data indicative of the first feature representations.

17. The computer-implemented method of claim 16, wherein:
the first model head is configured to selectively transmit one or more of the first feature representations to the second model head based on at least in part on one or more inference criteria associated with inference generation by the multi-headed machine-learned model.

18. The computer-implemented method of any of claim 13, wherein:
the first model head is configured to generate a first set of compressed feature representations based at least in part on the sensor data and a machine-learned compression; and
training, by at least the first computing device, the multi-headed machine-learned model comprises determining the machine-learned lossy compression based at least in part on the one or more training constraints.

19. A computing system, comprising:
one or more processors; and
one or more non-transitory computer-readable media that collectively store a multi-headed machine-learned model that is configured for distribution across a plurality of computing devices including the computing device, wherein the multi-headed machine-learned model is configured to generate inferences associated with at least one of a gesture detection or a movement recognition, the multi-headed machine-learned model comprising a first model head provisioned at a first computing device and configured to receive input data, wherein the first model head is configured to generate a first set of feature representations based at least in part on the input data and to determine whether the first set of feature representations satisfies one or more machine-learned inference criteria, the first model head configured to generate at least one inference based at least in part on the input data in response to the first set of feature representations satisfying one or more machine-learned inference criteria and to initiate a transmission of data associated with the first set of feature representations to a second model head at a second computing device in response to the first set of feature representations failing to satisfy the one or more machine-learned inference criteria.

20. The computing system of claim 19, wherein the first model head is configured to:
in response to determining that the first set of feature representations satisfies the one or more machine-learned inference criteria, transmit the at least one inference from the first computing device to the second computing device.

21. The computing system of claim 19 wherein the first model head is configured to:
in response to determining that the first set of feature representations fails to satisfy the one or more machine-learned inference criteria, generate a first set of compressed feature representations based at least in part on the first set of feature representations;
wherein the data associated with the first set of feature representations includes the first set of compressed feature representations.

22. The computing system of claim 21, wherein:
the first set of compressed feature representations is generated using one or more first machine-learned compression parameters; and
the multi-headed machine-learned model is trained to determine the one or more first machine-learned compression parameters based at least in part on one or more first training constraints that are representative of one or more computing parameters associated with at least one of the first computing device or the second computing device.
